(19) United States
(12) Patent Application Publication
(10) Pub. No.: US 2013/0246151 A1
(43) Pub. Date: Sep. 19, 2013

(54) Method And System To Enable Brands To Build Affinity Based Loyalty Networks

(71) Applicant: Sri Raghavan, Bangalore (IN)

(72) Inventor: Sri Raghavan, Bangalore (IN)

(21) Appl. No.: 13/658,680

(22) Filed: Oct. 23, 2012

Related U.S. Application Data
(60) Provisional application No. 61/610,888, filed on Mar. 14, 2012.

(51) Int. Cl. G06Q 30/02

(52) U.S. Cl. CPC G06Q 30/0226
USPC 705/14.27

(57) ABSTRACT

Techniques disclosed herein provide a brand loyalty program environment. Brand providers having loyalty programs may be enabled to initiate relationships between or among themselves and form a loyalty program affinity group. Brand providers in the loyalty program affinity group may together or individually decide to offer products or services. Brand providers within the loyalty program affinity group may be provided with monetary or non-monetary (e.g., points) credits or funds, acknowledgement following a purchase, or recognition at the time of display of an available transaction to a loyalty program member or following a purchase by the member for earned values These techniques help brand providers lower their overall marketing, customer acquisition, or sales costs and enable consumers or businesses to attain a reward sooner than possible through individual or other forms of loyalty programs.

### RELATED APPLICATION

This application claims the benefit of U.S. Provisional Application No. 61/610,888, filed on Mar. 14, 2012, the entire teachings of which are incorporated herein by reference.

### BACKGROUND OF THE INVENTION

Loyalty programs are generally used to help businesses develop and maintain participant loyalty and are used as marketing tools to develop new clientele. A frequent flyer program is an example of a typical loyalty program, where the more the participant uses a particular airline or group of affiliated airlines, the more frequent flyer miles the participant earns. After accumulating frequent flyer miles, the participant may choose to redeem those miles for upgrades in service or free airline tickets.

### SUMMARY OF THE INVENTION

Techniques disclosed herein provide a method, or corresponding apparatus of providing a brand loyalty program environment. The method may comprise enabling a first brand provider having a first loyalty program to initiate a relationship between itself and at least one second brand provider having at least one respective second loyalty program. The first brand provider and at least one second brand provider within the relationship may compose a loyalty program affinity group, the loyalty program affinity group may be managed within a server accessible by the first and at least one second brand providers via a computer network. The relationship may be a synergistic relationship allow for inventory trading or currency trading. The relationship may also allow for unidirectional or bi-directional inventory trading.

The method may enable brand providers within the loyalty program affinity group to specify a manner in which loyalty program members can combine and use earned values accumulated in the first loyalty program and the at least one respective second loyalty program to purchase goods or services associated with brands of the brand providers within the loyalty program affinity group via the computer network. The goods and services associated with brands of the brand providers may be sourced by at least one vendor that is not a brand provider within the loyalty program affinity group.

The manner specified by the brand providers for the loyalty members to combine and use earned values accumulated may include treating earned values in the first loyalty program and the at least one respective second loyalty program under a common value metric system even though purchasing prices for individual branded goods or services associated with brands of the brand providers may be markedly different. The manner specified may include enabling a loyalty program member to apply cash in purchasing the goods or services and may further enable non-monetary currencies to be combined with monetary currencies based on business rules at the time of redemption.

The manner specified may include converting loyalty program values of a first brand of the first brand provider to a second brand of the at least one second brand provider within the loyalty program affinity group by using an exchange rate unique to at least two brands, including the first brand and the at least one second brand. The exchange rate may be dynamically determined as a function of at least one of the following: brands associated with the purchase, goods or services associated with the purchase, time, attributes of a purchaser, or promotional offers.

The method may further comprise presenting to a loyalty program member representations of brands, for which the loyalty program member accumulates earned values, in connection with the respective earned values, within the first loyalty program and the at least one respective second loyalty program. The earned values accumulated in the first loyalty program and at least one respective second loyalty program may be stored in a database accessible by the server. The database may be accessible by the server via the computer network or may be accessible by the server by coupling the database to the server.

Presenting to the loyalty program member may include presenting at a centralized interface linking brand providers within the loyalty program affinity group accessible by the loyalty program member via the computer network. The method may include presenting to the loyalty program member via a client device via the computer network. The method may further comprise enabling a host brand provider to present to the loyalty program member the representations of the brands, wherein the loyalty program affinity group is unique to affinity relationships of the host brand provider. Presenting may include presenting at an interface associated with the host brand provider of the brand providers within the loyalty program affinity group accessible by the loyalty program member via the computer network.

The method may further enable a loyalty program member to earn values with any combination of the brands of the brand providers within the loyalty program affinity group. The method may further enable the loyalty program member to combine and use the earned values, in the manner specified by the brand providers within the loyalty program affinity group, to purchase the goods or services associated with the brands. The method may enable the loyalty program member to combine earned values by enabling the loyalty program member to combine earned values using at least one of the following: a mobile wallet, check-out payment processor, physical devices optionally including a Point of Sale (POS System), credit card payment terminal using a physical card, Near Field communication device, or radio frequency identification (RFID) device.

The method may further comprise determining a common loyalty program value metric for the goods or services associated with brands of the brand providers within the loyalty program affinity group. Determining the common loyalty program value metric for the goods and services associated with brands of the brand providers within the loyalty program affinity group may include calculating a rate of accrual of loyalty points associated with each brand represented.

The method may further comprise decrementing loyalty program values from each account associated with a loyalty program of the loyalty member as a function of how much value was combined from each account by the loyalty member used in making a purchase.

The method may further comprise enabling brand providers within the loyalty program affinity group to engage in a brand-to-brand (B2B) exchange of products or services with other brand providers within the loyalty program affinity group and to provide rewards to each others' loyalty program members through loyalty points at values below retail cash values of the products or services.

The method may further comprise presenting a loyalty program member at least one possible combination of the earned values from respective brands enabling the loyalty program member to purchase goods or services associated with brands of the brand providers within the loyalty program affinity group. Further, the method may comprise accepting input from the loyalty program member to adjust the at least one possible combination of the earned values from respective brands. Upon receiving the input, the method may include automatically recalibrating other earned values from respective brands within the at least one possible combination to enable the loyalty program member to purchase goods or services associated with brands of the brand providers within the loyalty program affinity group.

The method may further comprise enabling a loyalty program member of the first loyalty program to join the at least one respective second loyalty program of the at least one second brand provider within the loyalty program affinity group for which the loyalty program member is not currently a member.

The method may further comprise profiling a consumer base of a plurality of brand providers at the server, determining a commonality metric between the consumer base of the plurality of brand providers, and based on the commonality metric, the method may determine whether a synergistic relationship may be formed between at least a subset of the plurality of brand providers. The method may further comprise providing a recommendation to at least one brand provider of the subset of the plurality of brand providers to form a synergistic relationship with at least one of the brand providers of the subset of the plurality of brand providers. Further, the first brand provider having the first loyalty program may initiate the relationship between itself and the at least one second brand provider based on the recommendation.

The method may further comprise accepting a recommendation by the server to form a synergistic relationship with at least one of the brand providers of the subset of the plurality of brand providers. The first brand provider having the first loyalty program may initiate the relationship between itself and the at least one second brand provider based on the recommendation accepted.

The method may further comprise enabling brand providers to discover other brand providers with which to form a synergistic relationship using the commonality metric. The first brand provider having the first loyalty program may initiate the relationship between itself and the at least one second brand provider based on the discovery.

The method may further comprise providing the first brand provider and the at least one second brand provider within the loyalty program affinity group with credit, acknowledgement, or recognition for respective earned values accumulated in the first loyalty program or the at least one respective second loyalty program that are combined by a loyalty program member and used to purchase goods or services associated with brands of the brand providers within the loyalty program affinity group at the time of redemption. At the time of check out for a redemption of a reward for any product or service offered, brand providers within the loyalty program affinity group may be provided with monetary or non-monetary (e.g., points) credit, or funds, acknowledgement following a purchase, or recognition at the time of display, or following a purchase, for earned values within their loyalty programs that are used to purchase the product or service.

Further, according to techniques disclosed herein, a non-transient computer-readable medium may have encoded thereon a sequence of instructions which, when executed by a processor, may cause the processor to enable a first brand provider having a first loyalty program to initiate a relationship between itself and at least one second brand provider having at least one respective second loyalty program, the first brand provider and at least one second brand provider within the relationship composing a loyalty program affinity group, the loyalty program affinity group being managed within a server accessible by the first and at least one second brand providers via a computer network.

The sequence of instructions, when executed by the processor, may further cause the processor to enable brand providers within the loyalty program affinity group to specify a manner in which loyalty program members can combine and use earned values accumulated in the first loyalty program and the at least one respective second loyalty program to purchase goods or services associated with brands of the brand providers within the loyalty program affinity group via the computer network.

It should be understood that embodiments of the present invention can be implemented in the form of a method, apparatus, system, or computer readable medium with program codes embodied thereon. In general, it should be understood that elements of the method, block, and flow diagrams described herein may be implemented in software, hardware, firmware, as understood by one of ordinary skill in the art. Example embodiments of the present invention may include a non-transitory computer readable medium containing instructions that may be executed by a processor, and, when executed, cause the processor to complete methods described herein. For ease of reading, the term “system” is used in various portions of the description and may represent some or all forms of embodiments and implementations of the present invention, such as systems, methods, apparatuses, devices, computer readable media, network nodes, and networks.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A is a diagram of multiple parties and computer infrastructure supporting a brand loyalty program environment.

FIG. 1B illustrates an another example of multiple parties and computing infrastructure for supporting a brand loyalty program environment.

FIG. 2 illustrates an example of an established relationship between brand providers.

FIG. 3 is a diagram illustrating an interface for providing a brand loyalty program.

FIG. 4 is a diagram illustrating an interface for providing a brand loyalty program in which brand providers are acknowledged at the time of redemption.

FIG. 5 is a diagram illustrating a receipt that may be provided by a brand loyalty program that enables the brand providers to gain recognition for the benefits they have offered.

FIG. 6A is a flow diagram of a method of providing a brand loyalty program environment.

FIG. 6B is another flow diagram of a method of providing a brand loyalty program environment.

FIG. 7 shows a flow diagram of an embodiment of a method for enabling brand providers within the loyalty program affinity group to specify a manner in which loyalty program members can combine and use earned values accumulated.

FIG. 8 shows a flow diagram of embodiments of a method for presenting loyalty program members representations of brands, for which the loyalty program member accumulates earned values, in connection with the respective earned values.

FIG. 9A is a flow diagram of another embodiment of a method of providing a brand loyalty program environment.

FIG. 9B is block diagram showing an embodiment of a first brand provider having a first loyalty program and at least one second brand provider having a second loyalty program forming a loyalty program affinity group.

FIG. 10 is a flow diagram of another embodiment of a method of providing a brand loyalty program environment.

FIG. 11A is a block diagram illustrating payment flow of a system for processing loyalty payments and cash payments in accordance with techniques disclosed herein.

FIG. 11B is a block diagram of a physical device that may be provided at a retail store that enables customers to identify themselves.

FIG. 12 illustrates an embodiment of a cooperative loyalty engine operating in a system.

FIG. 13 is a block diagram of an embodiment of the flow of communication including status information for a points plus cash transaction.

FIG. 14 is a block diagram of another embodiment of the flow of communication for a points plus cash transaction.

FIG. 15 is a block diagram of another embodiment of the generic flow of communication for transactions according to techniques disclosed herein.

FIG. 16 is a block diagram of another embodiment of the flow of communication for a points-only transaction flow.

FIG. 17 is a block diagram of the internal structure of a computer in which various embodiments of the present invention may be implemented.

FIG. 18A-G illustrate examples of a user screen experiences with a web application according to techniques disclosed herein.

FIG. 19A-Q illustrate examples of a user screen experiences with a web application according to techniques disclosed herein.

### DETAILED DESCRIPTION OF THE INVENTION

A description of example embodiments of the invention follows.

The average household in the U.S. has memberships with at least twelve loyalty rewards programs and is active with respect to their usage (defined as collecting and redeeming loyalty currency or rewards) in over six of the programs. A constraint of present day loyalty programs from a consumer standpoint is the inability to combine multiple loyalty currencies offered by different brand providers to attain a reward sooner than otherwise possible.

Further, under present day loyalty programs, consumers may aggregate loyalty rewards that brand providers are willing to provide when the brand providers offer their loyalty rewards under a third party operated program, often referred to as a Coalition Loyalty Program. A Coalition Loyalty Program may use a third party neutral currency and may also have its own third party program brand name. However, brand providers participating in such Coalition Loyalty Programs are at a disadvantage with respect to fostering loyalty towards themselves, as the consumer may not be able to directly attribute their redemption of loyalty currency as a reward enabled by the brand provider or brand providers that provided or paid for the reward.

Further, present day loyalty programs may allow for the conversion of one loyalty currency (e.g., non-monetary currency) into another loyalty currency. For example, multiple disparate loyalty awards issued by different brands in different loyalty currencies may all be converted to one single brand currency. However, reward redemption happens in only one loyalty currency, and the conversion of one currency to another does not result in any recognition/credit/acknowledgement for the brand provider whose currency was converted to another at the time of reward redemption for a product or service.

Techniques disclosed herein are built on the idea that brand providers may be less averse to allowing their consumers to combine multiple loyalty currencies including their own, to attain a reward sooner, so long as brand providers receive credit/acknowledgement/recognition for having contributed to even a portion of that reward at the time of redemption.

According to techniques disclosed herein, brand providers may be enabled to determine, initiate, and set up (e.g., configure) mutually beneficial relationships with other synergistic, non-competing brand providers. Techniques disclosed herein may provide an environment within which such relationships may be configured. The environment may further enable brand providers to acquire new customers from one another, arrange a B2B exchange or swap of products and services offered to each others' customer base, and facilitate trial. Further, according to techniques disclosed herein, brand providers may enable each others' loyalty program participants (e.g, loyalty program members) to combine their loyalty currencies across loyalty programs to redeem rewards sooner than otherwise possible.

The unique nature and ability of a brand provider to swap products and services with other synergistic brand providers of their choosing is particularly beneficial when it is done on an ‘at cost’ basis. An ‘at cost’ basis helps to lower the costs of rewards redemption for the brand providers that are co-operating. The value of such ‘at cost’ provisioning of products and services may also be passed along to the end consumer (e.g., loyalty program member) through a very low price in terms of loyalty currency required for redemption of an award for those products and services.

In addition, techniques disclosed herein may help brand providers to lower their overall marketing and customer acquisition (or sales costs) considerably. For example, techniques disclosed herein may enable acceptance of multiple non-monetary currencies, such as loyalty points, along with the rendering of an advertisement of a brand of the participating brand provider or loyalty program that is providing the benefit, at the time of check out for the redemption of a reward for any product or service, over the computer network (e.g., via the Internet) or at a physical location. Further, according to techniques disclosed herein, specific rewards may be promoted as either a combination of multiple brand provider currencies or a single brand provider currency for specific periods of time to specific consumers.

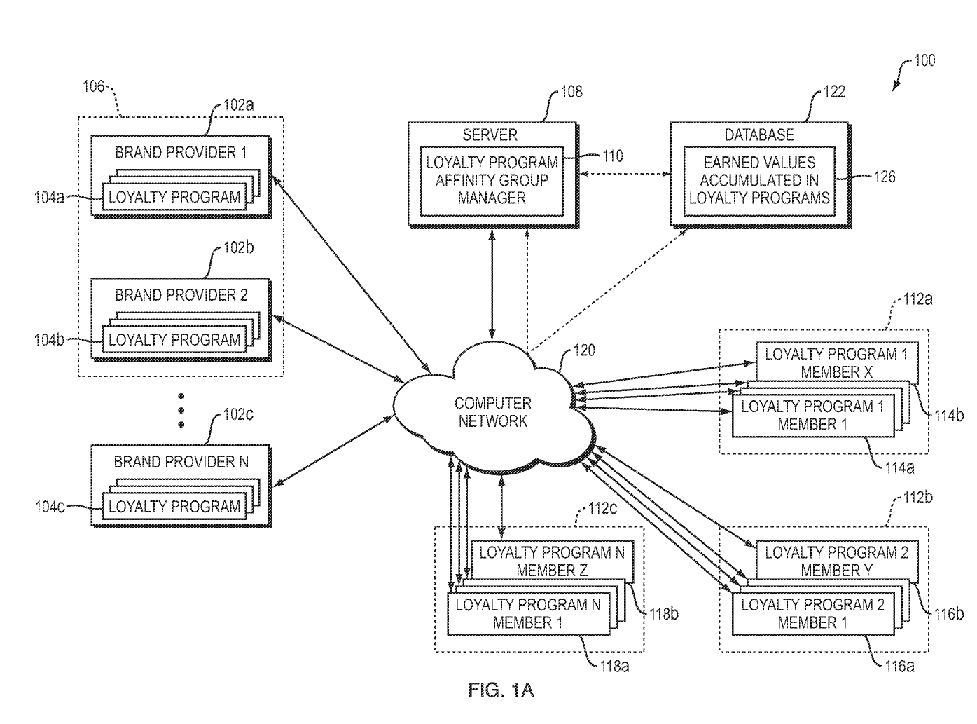

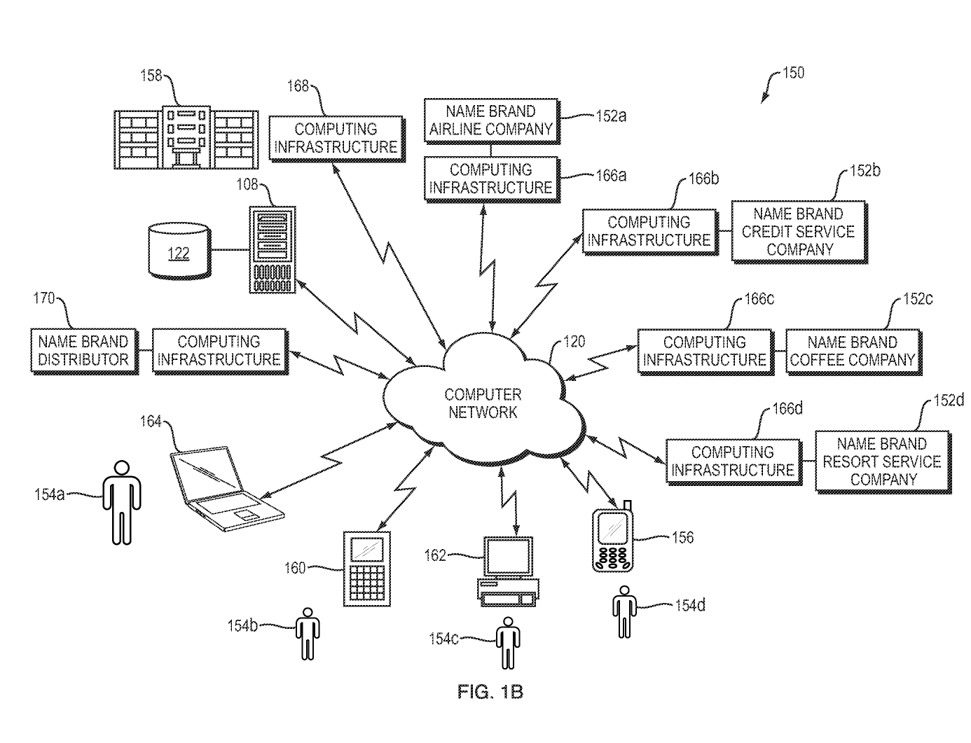

FIG. 1A is a diagram 100 of multiple parties and computer infrastructure supporting a brand loyalty program environment. The brand loyalty program environment 100 may include multiple brand providers 102a-102c. Each brand provider may provide at least one respective loyalty program 104a-104c to consumers. Each loyalty program 104a-104c may have a set 112a-112c of respective loyalty program members, such as members 114a-114b, 116a-116b, and 118a-118b shown. A first brand provider 102a and at least one second brand provider 102b may compose a loyalty program affinity group 106. Techniques disclosed herein may enable a first brand provider 102a having a first loyalty program 104a to initiate a relationship between itself and at least one second brand provider 102b having at least one respective second loyalty program 104b. The relationship may be a synergistic relationship, meaning that the combination has a value greater than the sum of the individual brand providers from the perspective of consumers or brand providers. Brand providers may cooperate providing an enhanced benefit. The relationship may be initiated via communication over a computer network 120. The loyalty program affinity group may together or individually decide to offer products and services. The products and services may be sourced from vendors outside the affinity group. There is no limitation from where products and services offered for redemption are sourced.

The brand loyalty program environment may include a server 108 that includes a loyalty program affinity group manager 110. The server 108 may be coupled to a database 122 or may access one or more databases via a computer network 120. The server 108, brand providers 102a-102c, and loyalty program members 114a-114b, 116a-116b, and 118a-118b, may all communicate with each via the computer network 120. The loyalty program affinity group 106 may be managed within the server 108 accessible by the first and at least one second brand providers via the computer network 120. The database 122 may store earned values accumulated 126 in the first loyalty program 104a and at least one respective second loyalty program 104b. According to another embodiment, the server 108 may be accessible over the cloud by providing computing infrastructure configured at each brand provider site.

FIG. 1B illustrates another example 150 of multiple parties and computer infrastructure for supporting a brand loyalty program environment. FIG. 1B illustrates brand providers 152a-152d, loyalty program members 154a-154d, server 108, retail store 158 (e.g., brand provider), and distributor 170 (e.g, brand provider) that may communicate via the computer network 120. The retail store 158 and brand providers 152a-152d may be coupled to the computer network 120 via respective computing infrastructure 168, and 166a-166d. Computing infrastructure may be any suitable infrastructure known by a person skilled in the art and may include one or more computing devices coupled to one or more computing networks, etc. A connection may be wired or wireless. A computer network and coupling connections therein may be wired, wireless, or a combination thereof. A computer network, computing infrastructure, and client device may be implemented in any suitable manner known by a person skilled in the art.

Techniques disclosed herein may be found applicable in any computer or operating system such as a complicated multi-user computing apparatus, a single user workstation, an embedded control system, handheld devices such as a PDA, mobile phone, and the like. Techniques disclosed herein may be applicable in any situation in which a user of a device works with a graphical user interface. Further, techniques disclosed herein may be found applicable in any computing system that interacts with a user of a device via speech and does not require a graphical user interface.

Client devices may include and are not limited to a variety of electronic devices such as desktop computers 162, and portable electronic devices such as mobile phones 156, personal digital assistants (PDAs) 160, pocket personal computers (not shown), laptop computers 164, etc. The loyalty program members may be coupled to the computer network 120 via various client devices 156, 160, 162, and 164. It should be apparent to a person skilled in the art that any device, e.g. electronic devices, portable electronic devices, handheld electronic devices and the like, which include at least a processor and configured to execute instructions and a memory fall within the scope of the present disclosure.

A loyalty program member may be enabled to combine earned values using at least one of the following (not shown): a mobile wallet, check-out payment processor, physical devices optionally including a Point of Sale (POS System), credit card payment terminal using a physical card, Near Field communication device, or radio frequency identification (RFID) device. For example, according to techniques disclosed herein, a loyalty program member may be enabled to register themselves on a client device using a unique identification and password.

The loyalty program member may link their multiple loyalty program memberships under one account managed on the server 108 having the loyalty program affinity group manager 110. The loyalty program member may be enabled to select a particular loyalty program and orchestrate a search for rewards available within that loyalty program. At redemption time, the loyalty program member may be enabled to combine other brand currencies permitted by a loyalty program and subject to any limiting business rule. The loyalty program member may be enabled to carry the information about multiple loyalty programs on a client device to a retail store 158 or a service location (not shown) and further use the device to combine multiple brand currencies subject to business rules at the point of redemption. The client device may be carried by the loyalty program member and may be configured to communicate with a device (not shown) at a retail store 158 or service location to enable the loyalty program member to select and to combine multiple reward currencies subject to business rules.

According to techniques disclosed herein, a mobile application may push offer information (for products and services that can be redeemed using points or cash or a combination) from the server 108 to the mobile phone 156 of a loyalty program member 154d. The offer information may be transformed to a QR code and/or a bar code using an embedded code generator. The QR code and/or a bar code may be scanned by the retailer. Points and/or cash combination offers may be location based offers, for example, offers may be based on loyalty program member's location respective to stores nearby. The offers may be protected on the mobile phone by enabling a loyalty program member to configure a pin number that may be required at a time of redemption or purchase of the products/services presented via the offer.

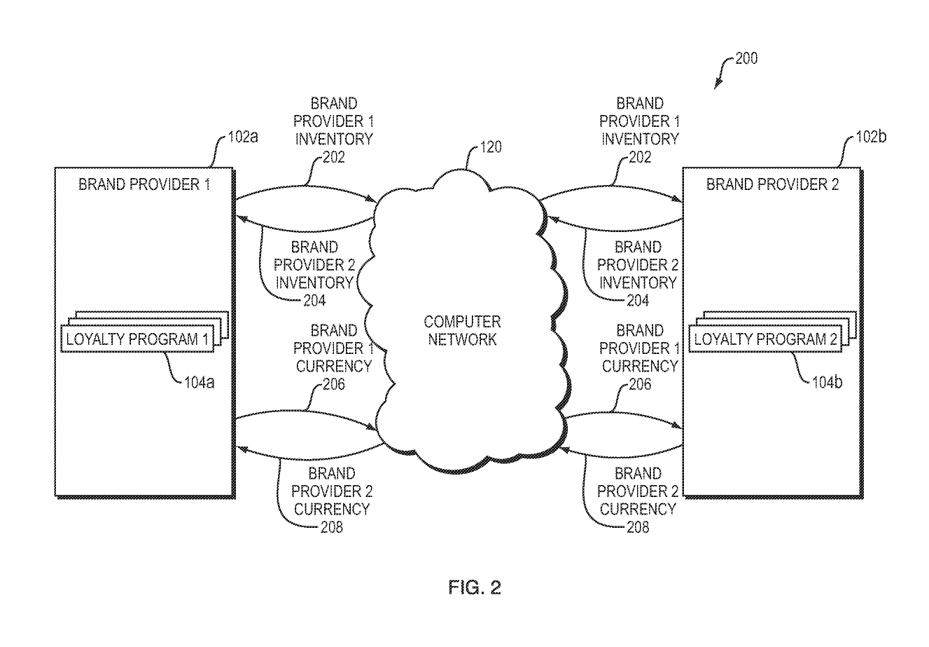

FIG. 2 illustrates examples of an established relationship 200 between brand providers. For example, the synergistic relationship may allow for inventory trading such as 202 and 204 shown, or a currency trading, such as 206 and 208 shown. The relationship may also allow for unidirectional (not shown) or a bi-directional inventory or currency trading.

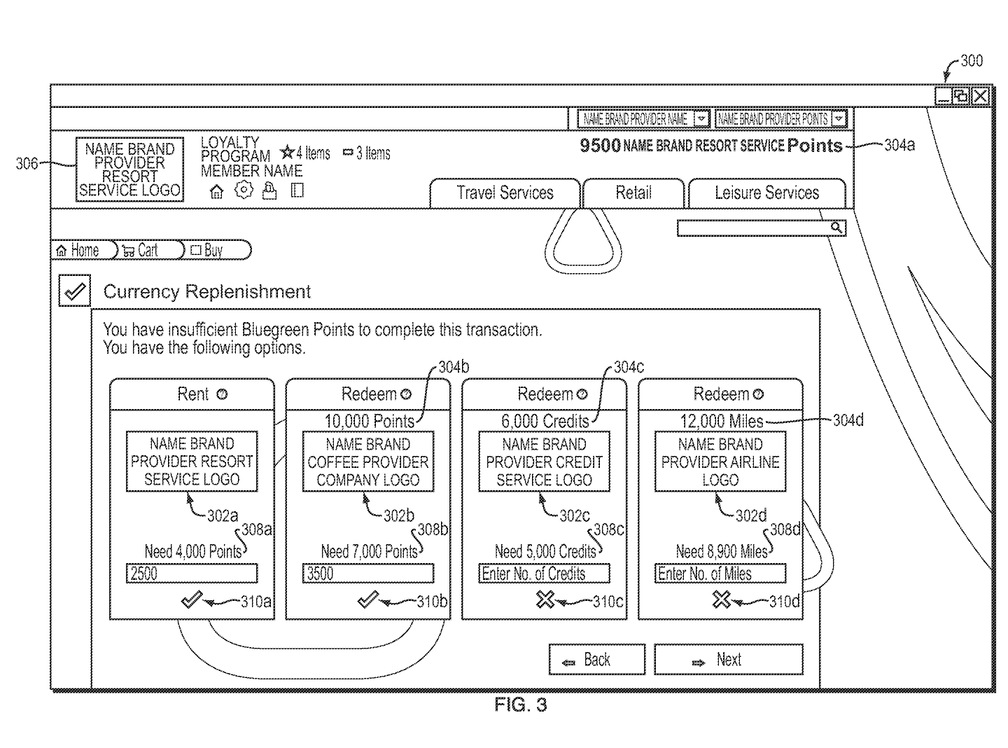

FIG. 3 is a diagram illustrating an interface 300 for providing a brand loyalty program. The interface 300 may present to a loyalty program member (not shown) representations of brands 302a-302d, for which the loyalty program member accumulates earned values, in connection with the respective earned values 304a-304d within the loyalty programs. The loyalty program affinity group may be unique to affinity relationships of a host provider (306). The interface 300 may be associated with the host brand provider 306 of the brand providers within the loyalty program affinity group. Alternatively the interface 300 may be a centralized interface linking brand providers within the loyalty program affinity group accessible by loyalty program members. The interface 300 may be accessible by the loyalty program member via the computer network. Loyalty program members may access the interface 300 via a client device via the computer network 120.

The interface 300 may present a loyalty program member at least one possible combination 308a-308d of the earned values from respective brands enabling the loyalty program member to purchase goods or services associated with brands of the brand providers within the loyalty program affinity group. The interface 300 may be configured to accept input 310a-310d from the loyalty program member to adjust the at least one possible combination of the earned values from respective brands. Upon receiving the input, the interface may be configured to automatically recalibrate other earned values from respective brands within the at least one possible combination to enable the loyalty program member to purchase goods or services associated with brands of the brand providers within the loyalty program affinity group.

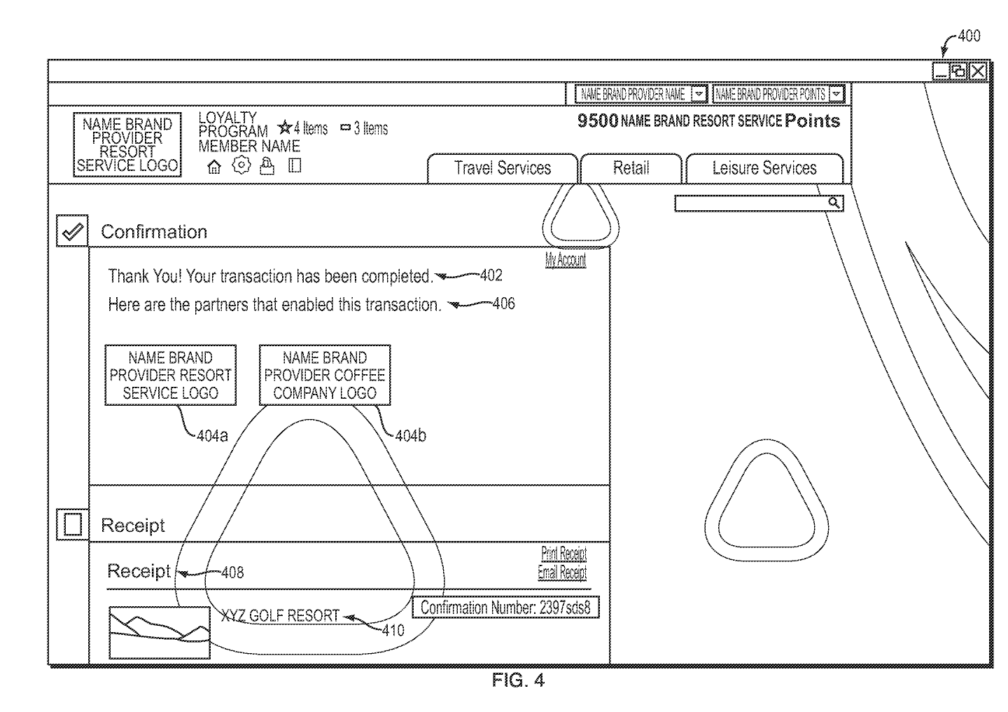

FIG. 4 is a diagram illustrating an interface 400 for providing a brand loyalty program in which brand providers are acknowledged at the time of redemption. For example, interface 400 illustrates a completed transaction 402 whereby brand providers 404a and 404b within the loyalty program affinity group are provided with credit, acknowledgement, or recognition 406 for respective earned values accumulated in the brand providers' loyalty programs that are combined by a loyalty program member and used to purchase goods or services associated with brands of the brand providers 410 within the loyalty program affinity group at the time of redemption 408.

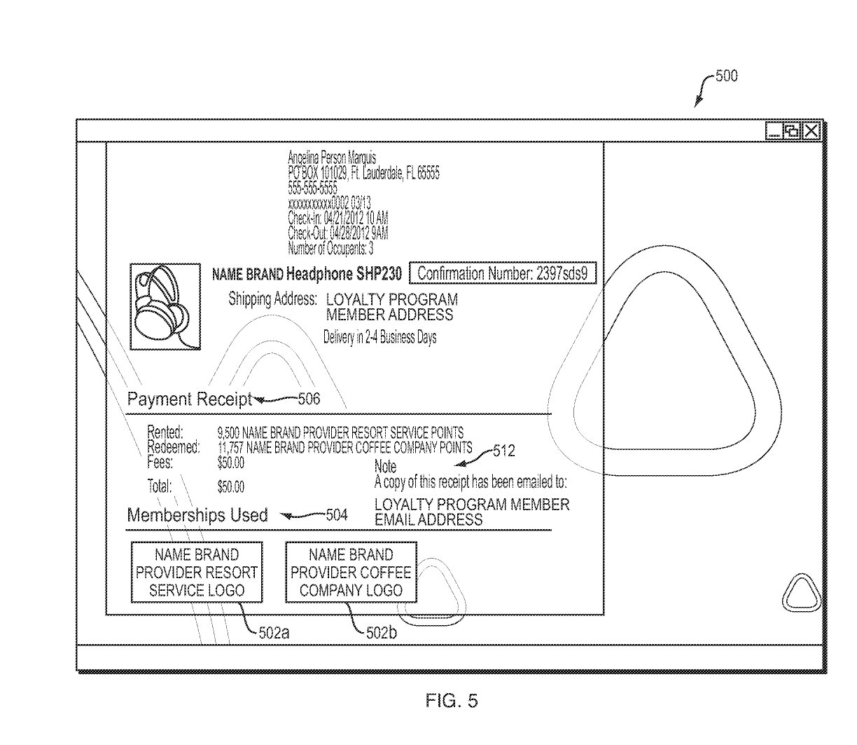

FIG. 5 is a diagram illustrating a receipt 500 that may be provided by a brand loyalty program that enables the brand providers 502a and 502b to gain recognition 504 for the benefits they have offered. The recognition 504 may be provided to the customer (e.g., loyalty program member) in the transaction 506 for which the receipt 500 is generated. The receipt may be provided by being presented to the loyalty program member at the interface and may also be provided to the loyalty program member via email 512 sent to the loyalty program member over the computer network.

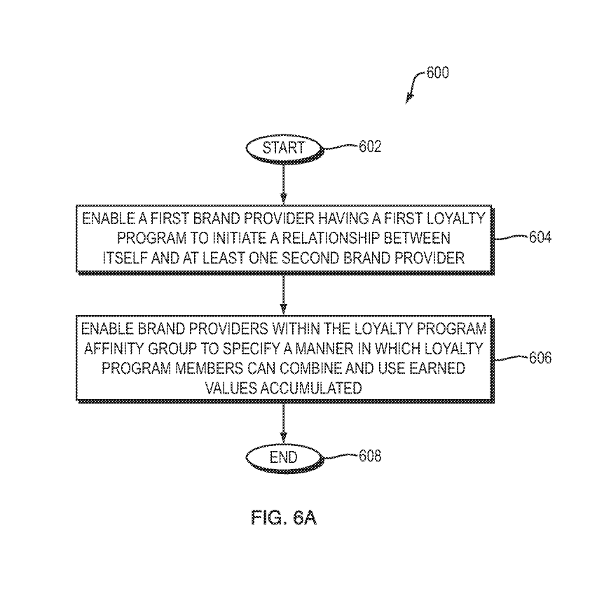

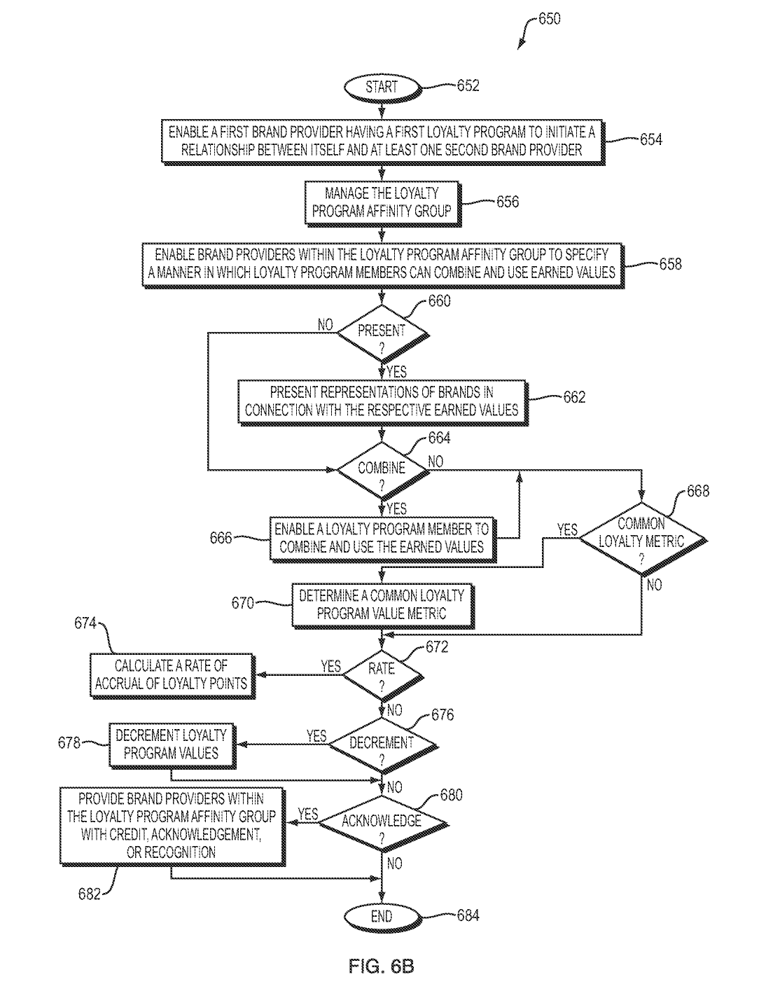

FIG. 6A is an embodiment of a flow diagram of a method of providing a brand loyalty program environment (600). The method may start (602) and enable a first brand provider having a first loyalty program to initiate a relationship between itself and at least one second brand provider having at least one respective second loyalty program, the first brand provider and at least one second brand provider within the relationship may compose a loyalty program affinity group, the loyalty program affinity group may be managed within a server accessible by the first and at least one second brand providers via a computer network (604). The method may further enable brand providers within the loyalty program affinity group to specify a manner in which loyalty program members can combine and use earned values accumulated in the first loyalty program and the at least one respective second loyalty program to purchase goods or services associated with brands of the brand providers within the loyalty program affinity group via the computer network (606), and the method may end (608).

FIG. 6B is a flow diagram of a method of providing a brand loyalty program environment (650). The method may start (652) and enable a first brand provider having a first loyalty program to initiate a relationship between itself and at least one second brand provider having at least one respective second loyalty program (654). The first brand provider and at least one second brand provider within the relationship may compose a loyalty program affinity group. The loyalty program affinity group may be managed within a server accessible by the first and at least one second brand providers via a computer network (656). The relationship may be a synergistic relationship including an inventory trading relationship or a currency trading relationship. The relationship may be a unidirectional or a bi-directional inventory trading relationship.

The method may enable brand providers within the loyalty program affinity group to specify a manner in which loyalty program members can combine and use earned values accumulated in the first loyalty program and the at least one respective second loyalty program to purchase goods or services associated with brands of the brand providers within the loyalty program affinity group via the computer network. Brand providers within the loyalty program affinity group may be enabled to specify various manners in which loyalty program members can combine and use earned values accumulated (658).

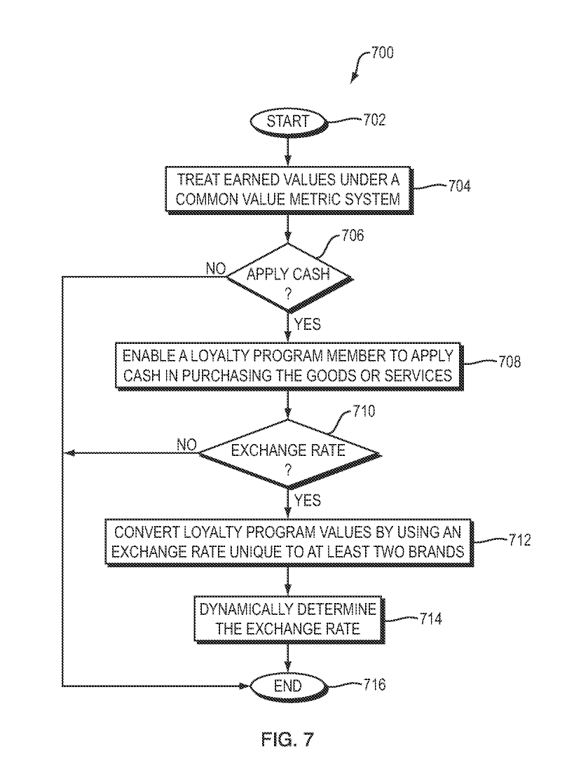

FIG. 7 shows a flow diagram of an embodiment of a method for enabling brand providers within the loyalty program affinity group to specify a manner in which loyalty program members can combine and use earned values accumulated (700). The method may start (702) and enable a manner specified that includes treating earned values in the first loyalty program and the at least one respective second loyalty program under a common value metric system even though purchasing prices for individual branded goods or services associated with brands of the brand providers may be markedly different (704).

A common value metric may be defined as an intermediate unit of measurement which is used to specify the conversion ratio between itself and the earned values of at least a first loyalty program and again the conversion values between itself and the earned values of at least a second loyalty program and so on until the conversion ratios have been specified for all the loyalty programs tied to that common value metric; thereby revealing through transitivity the exchange rate between the earned values of at least the first loyalty program and the earned values of the second loyalty program or any number of additional loyalty programs that are tied to such a common value metric. Such a method is different from directly specifying the exchange rate between the earned values of any first loyalty program and the earned values of any second loyalty program because, according to techniques disclosed herein, a change in the exchange rate between the earned values of any two loyalty programs does not impact the exchange rate between any third loyalty program which may be interacting independently with the loyalty programs (e.g., the two loyalty programs) whose exchange rate has been changed.

The method may determine if cash may be applied by a loyalty program member in purchasing goods or services (706). The method may enable the manner specified to include enabling a loyalty program member to apply cash in purchasing the goods or services (708). The method may determine if an exchange rate is to be determined (710). If so, the method may further enable the manner specified to include converting loyalty program values of a first brand of the first brand provider to a second brand of the at least one second brand provider within the loyalty program affinity group by using an exchange rate unique to at least two brands including the first brand and the second brand (712). The exchange rate may be dynamically determined as a function of at least one of the following: brands associated with the purchase, goods or services associated with the purchase, time, attributes of a purchaser, or promotional offers (714) and the method may end (716).

Turning back to FIG. 6B, the method 650 may determine whether or not to present a loyalty program member representations of brands (660). If so, the method may further present to a loyalty program member representations of brands, for which the loyalty program member accumulates earned values, in connection with the respective earned values, within the first loyalty program and the at least one respective second loyalty program (662). The earned values accumulated in the first loyalty program and at least one respective second loyalty program may be stored in a database accessible by the server. The server may be coupled to the database or the server may access the database via the computer network.

The method may further determine whether or not to combine earned values (664). If so, the method may further enable the loyalty program member to combine and use the earned values, in the manner specified by the brand providers within the loyalty program affinity group, to purchase the goods or services associated with the brands (666). The goods and services associated with brands of the brand providers may be sourced by at least one vendor that is not a brand provider within the loyalty program affinity group. The method may decide whether or not to determine a common loyalty program value metric (668). If so, the method may determine a common loyalty program value metric for the goods or services associated with brands of the brand providers within the loyalty program affinity group (670). The may determine whether or not to calculate a rate of accrual (672). If so, the method may calculate a rate of accrual of loyalty points associated with each brand represented (674). The method may further determine whether or not to decrement loyalty program values (676). If so, loyalty program values may be decremented from each account associated with a loyalty program of the loyalty member as a function of how much value was combined from each account by the loyalty member used in making a purchase (678). The method may further determine whether or not to provide credit, acknowledgement, or recognition for earned value contributed (680). If so, the method may further provide the first brand provider and the at least one second brand provider within the loyalty program affinity group with credit, acknowledgement, or recognition for respective earned values accumulated in the first loyalty program or the at least one respective second loyalty program that are combined by a loyalty program member and used to purchase goods or services associated with brands of the brand providers within the loyalty program affinity group at the time of redemption (682) and the method may end (684).

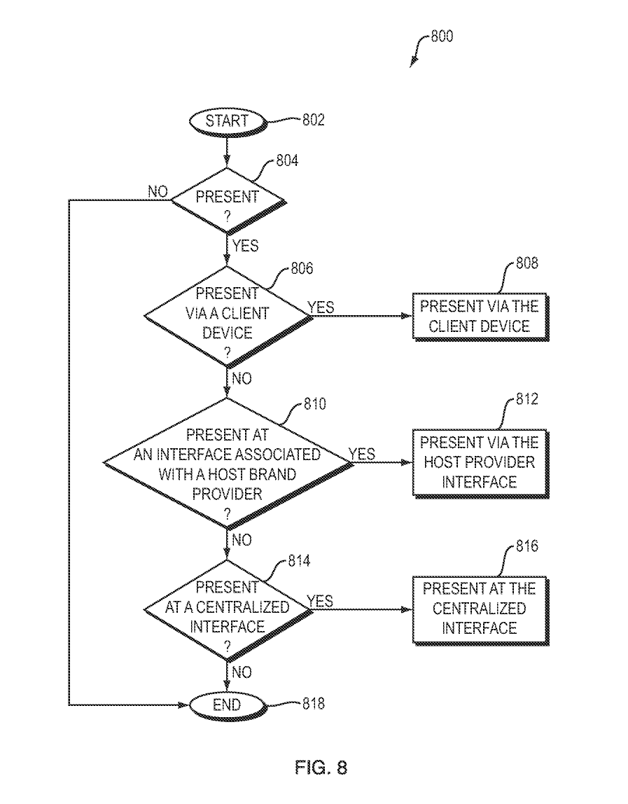

FIG. 8 shows a flow diagram of embodiments of a method for presenting loyalty program members representations of brands, for which the loyalty program member accumulates earned values, in connection with the respective earned values (800). The method starts (802) and determines whether or not to present (804). If not presenting, the method may end (818). If presenting, then a determination may be made whether or not to present via a client interface (806). If so, then presenting may include presenting representations of brands, for which the loyalty program member accumulates earned values, in connection with the respective earned values, via the client device via a computer network (808). Otherwise, a determination may be made whether or not to present at an interface associated with a host provider (810). If so, presenting may also include presenting at an interface associated with a host brand provider of the brand providers within the loyalty program affinity group accessible by the loyalty program member via the computer network (812). Presenting may include presenting representations of brands, for which the loyalty program member accumulates earned values, in connection with the respective earned values. Otherwise, a determination may be made whether or not to present at a centralized interface (814). If so, presenting may include presenting representations of brands, for which the loyalty program member accumulates earned values, in connection with the respective earned values, at a centralized interface linking brand providers within the loyalty program affinity group accessible by the loyalty program member via the computer network (816). The method may end (818).

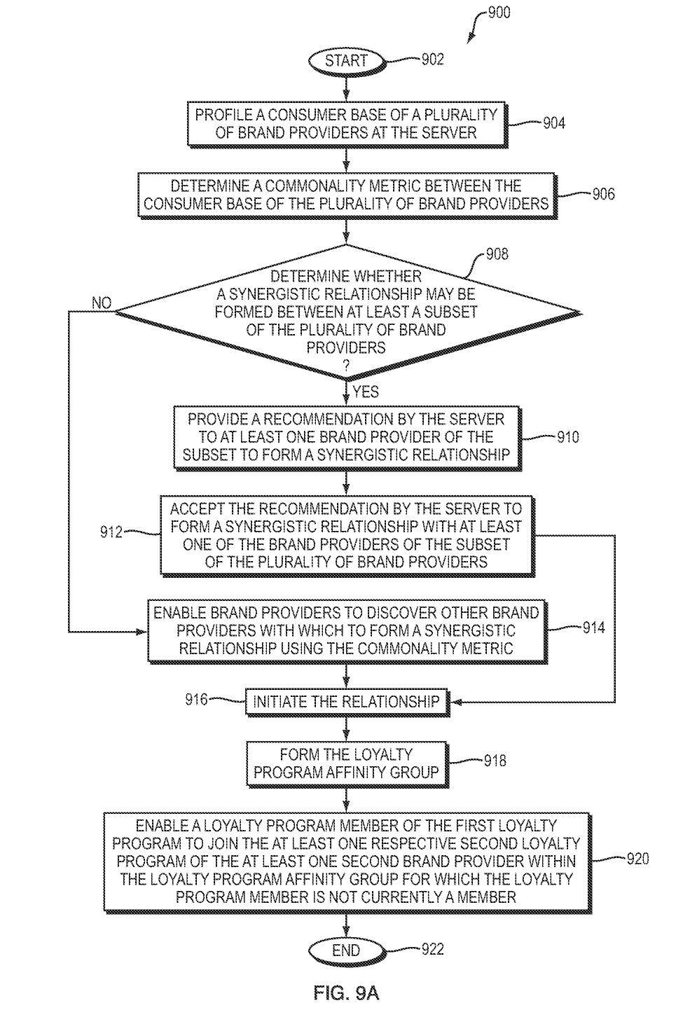

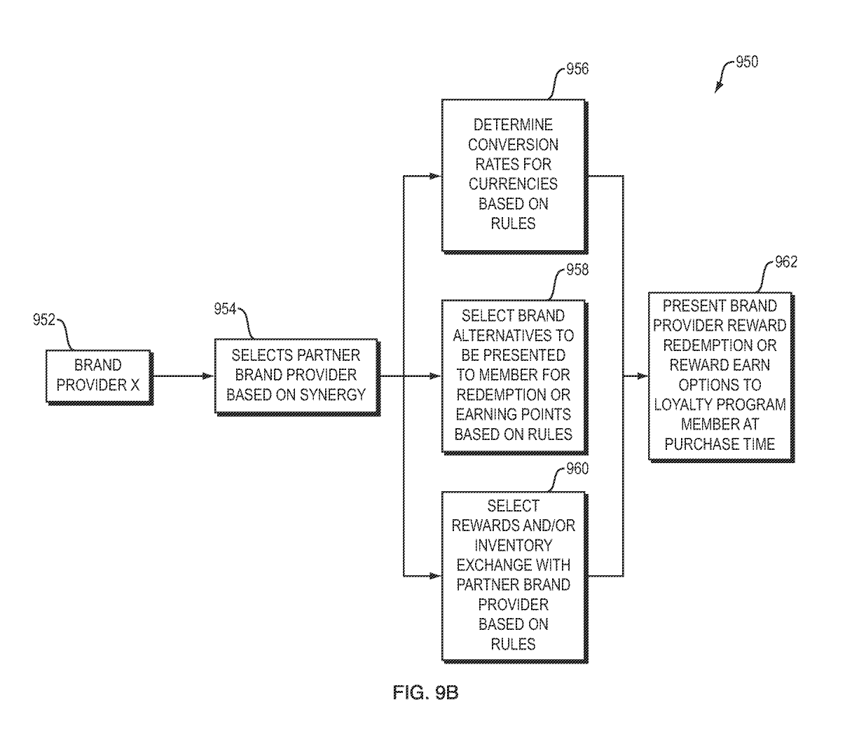

FIG. 9A is a flow diagram of another embodiment of a method of providing a brand loyalty program environment (900). The method may start (902) and profile a consumer base of a plurality of brand providers at the server (904). The method may determine a commonality metric between the consumer bases of the plurality of brand providers (906). Based on the commonality metric, the method may determine whether a synergistic relationship may be formed between at least a subset of the plurality of brand providers (908). If it is determined that a synergistic relationship may be formed, the method may further provide a recommendation to at least one brand provider of the subset of the plurality of brand providers to form a synergistic relationship with at least one of the brand providers of the subset of the plurality of brand providers (910). For example, the server 108 may enable aggregated data from the multiple loyalty programs 104a-c across consumers to be analyzed by brand providers 102a-102c with recommendations on synergistic brands to facilitate acquisition of new customers. Consumer data may be enriched with additional demographic data on the server to enable facilitating the analysis of matching demographic, psychographic, behavioral and other market segments of consumers that are valid for multiple brands of brand providers and to exploit such synergies across brands.

The recommendation by the server to form a synergistic relationship with at least one of the brand providers of the subset of the plurality of brand providers may be accepted (912). The first brand provider having the first loyalty program may initiate the relationship between itself and the at least one second brand provider (916). The relationship may be initiated based on the recommendation being accepted and the loyalty program affinity group may be formed (918).

According to another embodiment the method may enable brand providers to discover other brand providers with which to form a synergistic relationship using the commonality metric (914). The first brand provider having the first loyalty program may initiate the relationship between itself and the at least one second brand provider (914). The relationship may be based on the discovery. The loyalty program affinity group may be formed (918).

According to some embodiments the method may enable a loyalty program member of the first loyalty program to join the at least one respective second loyalty program of the at least one second brand provider within the loyalty program affinity group for which the loyalty program member is not currently a member (920) and the method may end (922).

FIG. 9B is block diagram 950 showing an embodiment of a first brand provider having a first loyalty program and at least one second brand provider having a second loyalty program forming a loyalty program affinity group. The first brand provider (952) may select the second brand provider base on synergy according to techniques disclosed herein (954). The first brand provider and the second brand provider may form a loyalty program affinity group. Synergy criteria may be based on purchase, member, award, time and other contextual variables. Conversion rates may be decided for currencies based on rules (956). Brands and brand alternatives of the brand providers may be presented to a loyalty program member of a loyalty program of the first or second brand provider. The brands and brand alternatives may be presented for redemption or for earning points based on rules (958). Rewards and/or inventory may be exchanged between the partnering first and second brand providers based on rules (960). Rules may be based on purchase, member, award, time and other contextual variables. Options may be presented to a loyalty program member at purchased time such as brand reward redemption options or reward earn options (962).

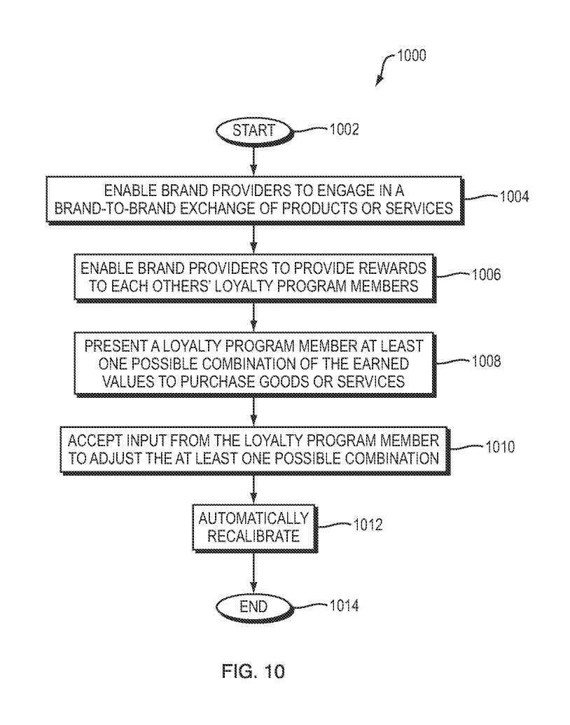

FIG. 10 is a flow diagram of another embodiment of a method of providing a brand loyalty program environment (1000). The method may start (1002) and enable brand providers within the loyalty program affinity group to engage in a brand-to-brand (B2B) exchange of products or services with other brand providers within the loyalty program affinity group (1004). The method may further enable brand providers within the loyalty program affinity group to provide rewards to each others' loyalty program members through loyalty points at values below retail cash values of the products or services (1006). The method may further present a loyalty program member at least one possible combination of the earned values from respective brands enabling the loyalty program member to purchase goods or services associated with brands of the brand providers within the loyalty program affinity group (1008). Further, the method may accept input from the loyalty program member to adjust the at least one possible combination of the earned values from respective brands (1010). Upon receiving the input, the method may further automatically recalibrate other earned values from respective brands within the at least one possible combination to enable the loyalty program member to purchase goods or services associated with brands of the brand providers within the loyalty program affinity group (1012) and the method may end (1014).

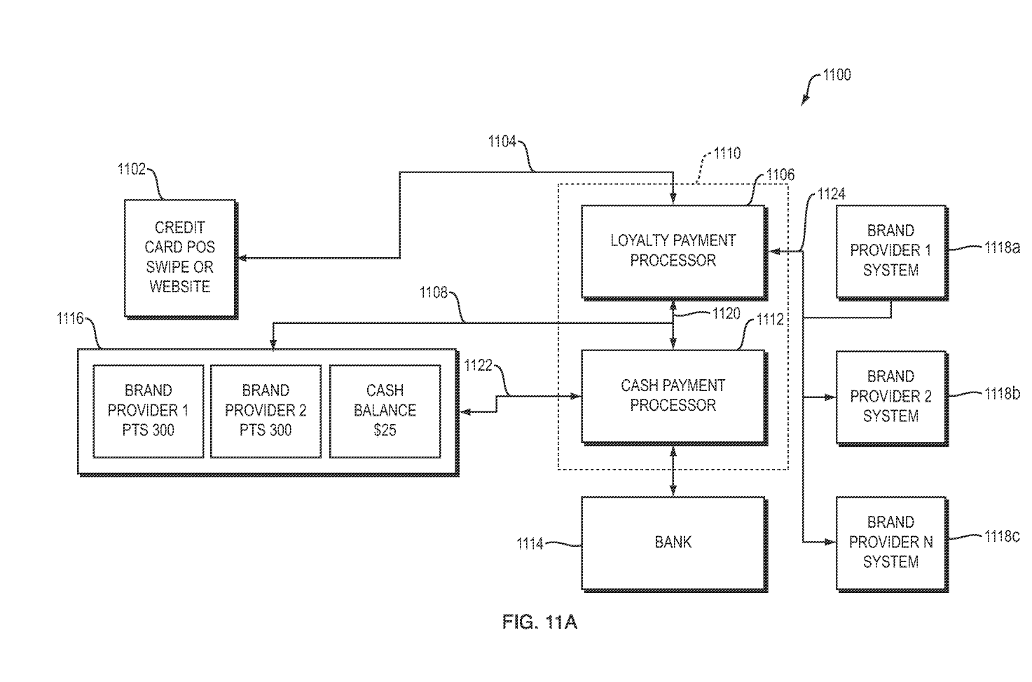

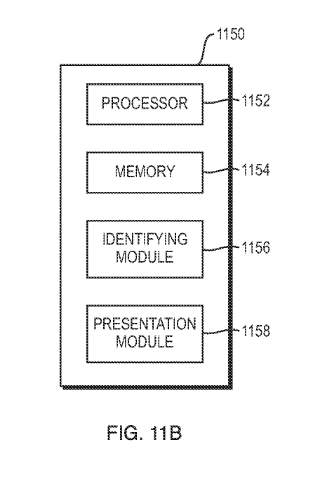

FIG. 11A is a block diagram illustrating payment flow of a system for processing loyalty payments and cash payments in accordance with techniques disclosed herein (1100). A payment engine 1110 may include a loyalty payment processor 1106 and a cash payment processor 1112. The loyalty payment processor 1106 and cash payment processor 1112 may be implemented as a single processor or multiple processors. The payment engine 1110 may be included in a server coupled to a computer network.

The payment engine 1110 may communicate with a bank 1114 over the computer network. According to techniques disclosed herein, a device 1102 may be provided such as a widget or module that may be incorporated into any website such that it may be invoked 1104 at check out time by the loyalty payment processor 1106. The device 1102 may enable a buyer (e.g., loyalty program member, not shown) to provide identification and be identified. Upon loyalty program member identification, the loyalty payment processor 1110 may retrieve loyalty program member account information 1114 such as loyalty and/or non-monetary currencies to be retrieved 1108 and presented according to techniques disclosed herein to the buyer to use as cash equivalents. Loyalty program member account information 1116 may be stored in a database coupled to the loyalty payment engine 1110 or accessible to the loyalty payment engine 1110 over the computer network. The loyalty payment engine 1110 may communicate with brand provider systems 1118a-c.

A server may include the loyalty payment engine 1110 and a network level entity (not shown). The network level entity may operate as an aggregator brand provider equivalent to a coalition program that may enable the server to subsume extant coalition reward program models. The network level entity may perform services such as a commission agent and may further enable aggregation of loyalty currencies with specific business rules and/or aggregates the provisioning of products and services. Further, methods disclosed herein may be implemented by the loyalty payment processor 1110. Methods of the loyalty payment processor 1110 may be enabled to be remotely, for example, some aspects may be invoked at the time of redemption via a device communicatively coupled to the loyalty payment processor or via a website. The loyalty payment processor 1110 may further be configured to configure and collect fees with the use of credit cards or other electronic payment mechanisms within the loyalty payment processor 1110. The payment flow may include a communication order such as 1104, 1108, 1120, 1122, and 1124.

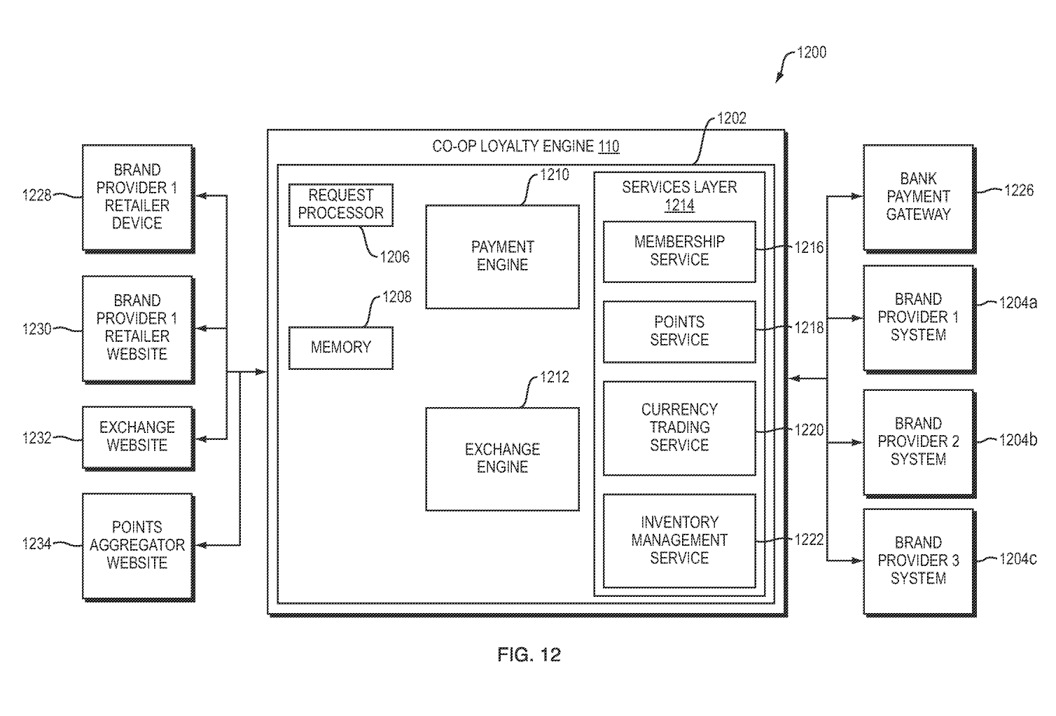

FIG. 11B is a block diagram of a physical device 1150 that may be provided at a retail store that includes a processor 1152, memory 1154, and an identifying module 1156 that enables customers to identify themselves using a card, biometric device, or virtual log-in with password. The device 1150 may be configured to communicate with a server over a computer network. Using the customer identification, the device 1150 may retrieve from the server via the computer network the available non-monetary currencies that may be used for purchase. The device may further include a presentation module 1158 that may display (via a physical device or via the computer network) the various representations of brands and their respective non-monetary loyalty currencies to be redeemed in part or whole and used along with other currencies. The presentation module 1158 may be configured to automatically configure a web page displayed by the device, or a display of the device, to display only the brands whose loyalty currencies are allowed for that reward redemption. The presentation module 1158 may be further configured to compute the combinations of currencies required for redemption of the reward and accept inputs from the consumer to recalibrate the combinations on the fly. A receipt may be provided to the customer that enables the brands to gain recognition for the benefits they have offered. The receipt may be provided to the customer in the transaction for which the receipt is generated. FIG. 12 illustrates an embodiment of a cooperative loyalty engine operating in a system 1200. A cooperative loyalty engine 1202 may be included in a server (not shown). The system 1200 may enable brand providers 1204a-c to determine the set of other brand provider currencies that would allow their own currency to be combined with at the time of redemption. The cooperative loyalty engine 1202 may include a request processor 1206, memory 1208, payment engine module 1210, exchange engine module 1212, and a services layer module 1214.

The services layer module 1214 may include a membership service module 1216, points service module 1218, currency trading service module 1220, inventory management service module 1222, and web services module 1224. The server may enable a swap or exchange of products and services simultaneously with the ability to combine multiple loyalty programs 104a-b between brand providers 102a-b that decide to cooperate to provide for redemption of rewards for their loyal consumers (e.g., their loyalty program members).

The server may communicate with systems of brand providers 1204a-c, bank payment gateway 1226, brand provider/retailer devices 1228, brand provider/retailer web-sites 1230, exchange web-sites 1232, and a points aggregator web-site 1234, via a the computer network. The server web services module 1224 may enable the server to automatically connect with brand providers' systems 1204a-c or to flexibly maintain information to enable any or all of the transactions or techniques described herein. Information needed to enable any or all of the transactions or techniques described herein may be distributed and stored on one or more databases or storage devices throughout the computer network or at a single storage location.

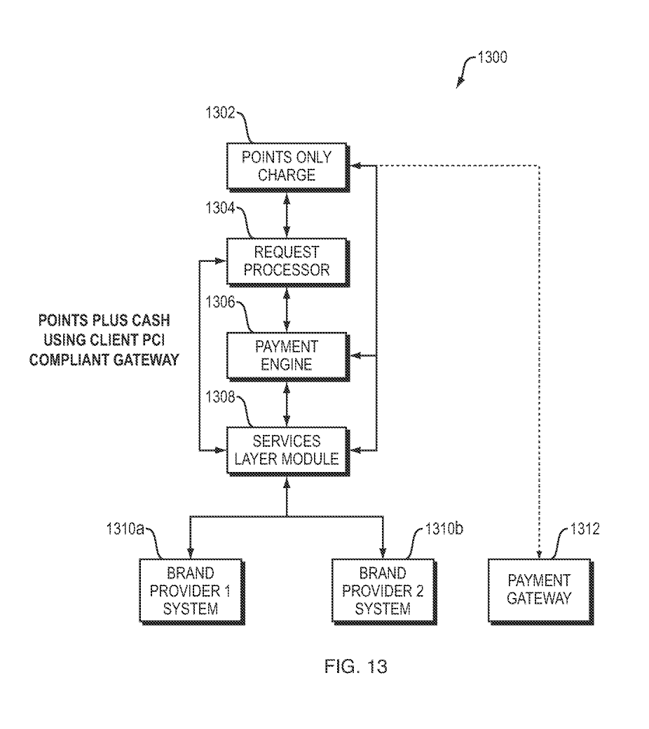

FIG. 13 is a block diagram of an embodiment of the flow of communication including status information for a points plus cash transaction 1300. The flow of communication may include using a client PCI compliant gateway. The block diagram includes communication flow between a request processor 1304, payment engine 1306, services layer module 1308, brand provider systems 1310a-b, and payment gateway 1312. A transaction may begin with a points only charge 1302 being communicated to the request processor 1304.

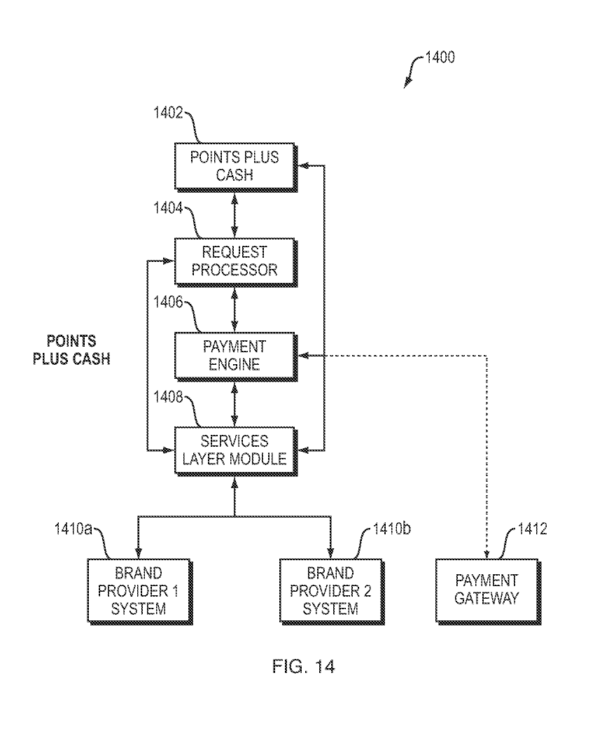

FIG. 14 is a block diagram of another embodiment of the flow of communication for a points plus cash transaction 1400. The flow of communication includes using a client PCI compliant gateway. The block diagram includes communication flow between request processor 1404, payment engine 1406, services layer module 1408, brand provider systems 1410a-b, and payment gateway 1412. A transaction may begin with a points plus cash transaction 1402 being communicated to the request processor 1404. Communication between the payment engine 1406 and the payment gateway 1412 may include status information.

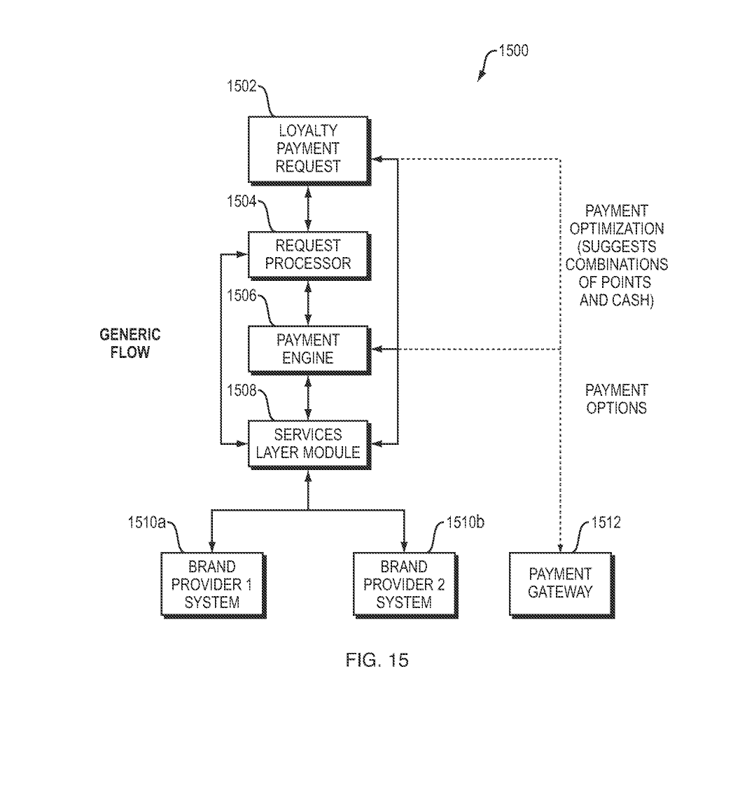

FIG. 15 is a block diagram of another embodiment of the generic flow of communication for transactions according to techniques disclosed herein 1500. A loyalty payment request 1502 may be communicated to a request processor 1504, services layer module 1508, and a payment gateway 1512. As illustrated, the request processor 1504 may communicate with a payment engine 1506 and the services layer 1508. Payment engine 1506 communicates with the request processor 1504 and services layer module 1508 and the payment gateway 1512. The services layer module 1508 may communicate with brand provider systems 1510a-b. The payment gateway 1512 may communicate payment optimization (suggested combinations of points and cash) and payment options with the payment engine 1506.

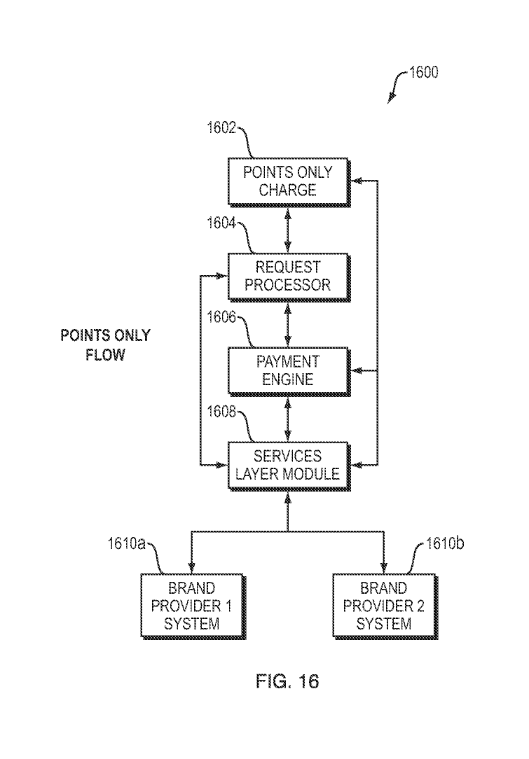

FIG. 16 is a block diagram of another embodiment of the flow of communication for a points only transaction flow 1600. The block diagram includes communication flow between request processor 1604, payment engine 1606, services layer module 1608, and brand provider systems 1610a-b. A transaction may begin with a points only charge 1602.

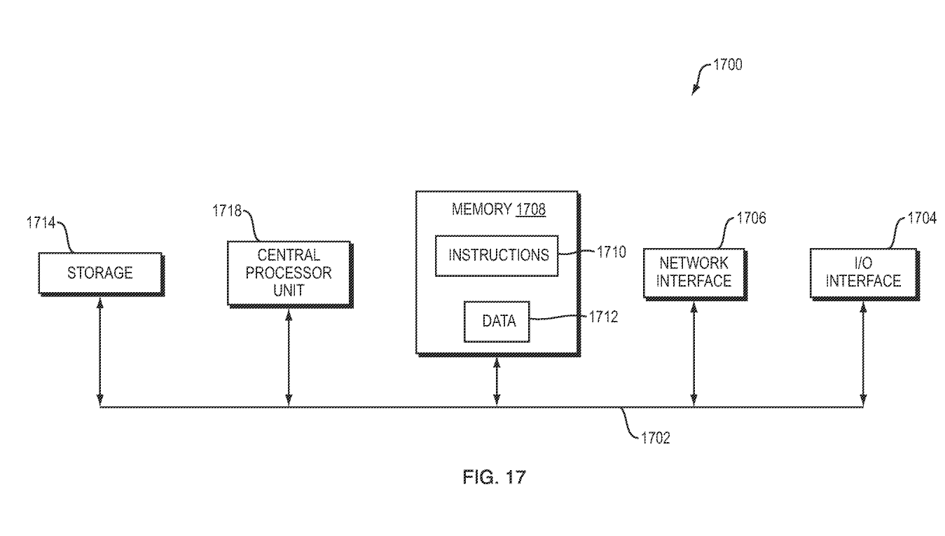

FIG. 17 is a block diagram of the internal structure of a computer 1700 in which various embodiments of the present invention may be implemented. The computer 1700 contains system bus 1702, where a bus is a set of hardware lines used for data transfer among the components of a computer or processing system. Bus 1702 is essentially a shared conduit that couples different elements of a computer system (e.g., processor, disk storage, memory, input/output ports, network ports, etc.) that enables the transfer of information between the elements. Coupled to system bus 1702 is I/O device interface 1704 for coupling various input and output devices (e.g., keyboard, mouse, displays, printers, speakers, etc.) to the computer 1700. Network interface 1706 allows the computer 1700 to couple to various other devices attached to a network. Memory 1708 provides volatile storage for computer software instructions 1710 and data 1712 may be used to implement embodiments of the present invention. Disk storage 1714 provides non-volatile storage for computer software instructions 1710 and data 1712 that may be used to implement embodiments of the present invention. Central processor unit 1718 is also coupled to system bus 1702 and provides for the execution of computer instructions.

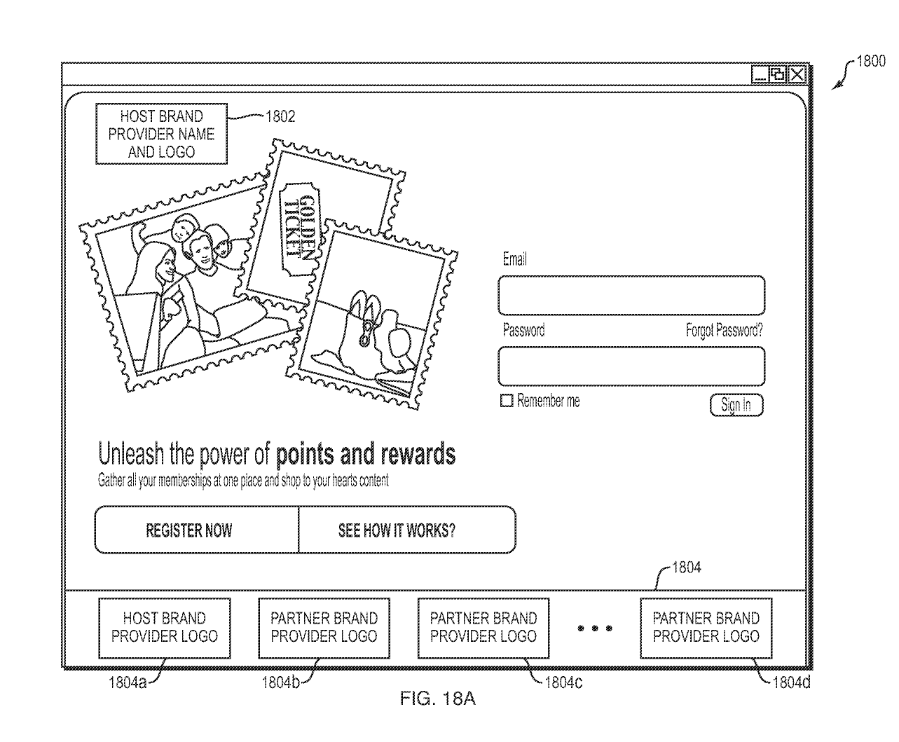

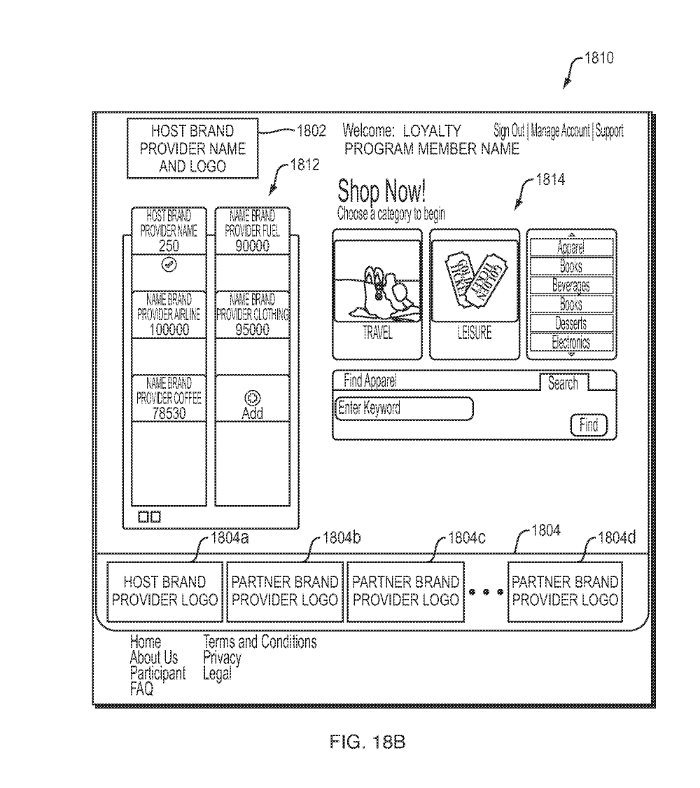

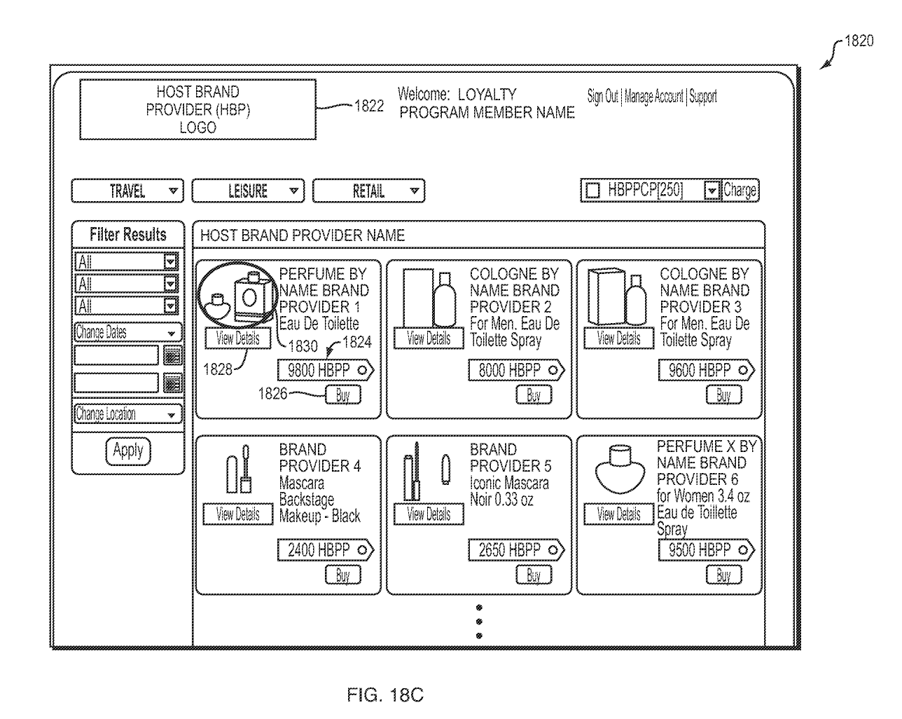

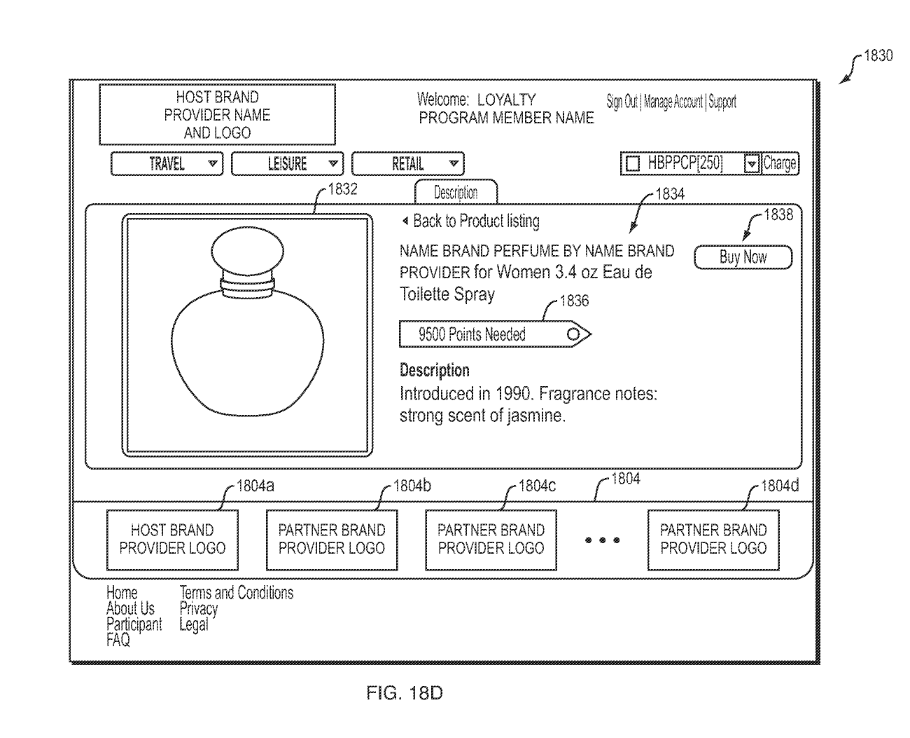

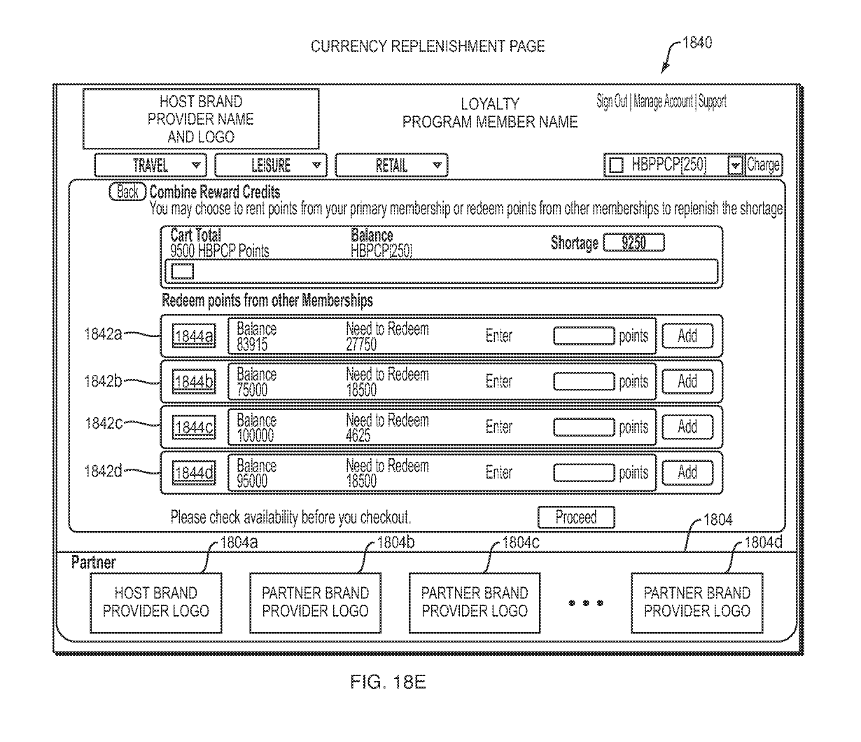

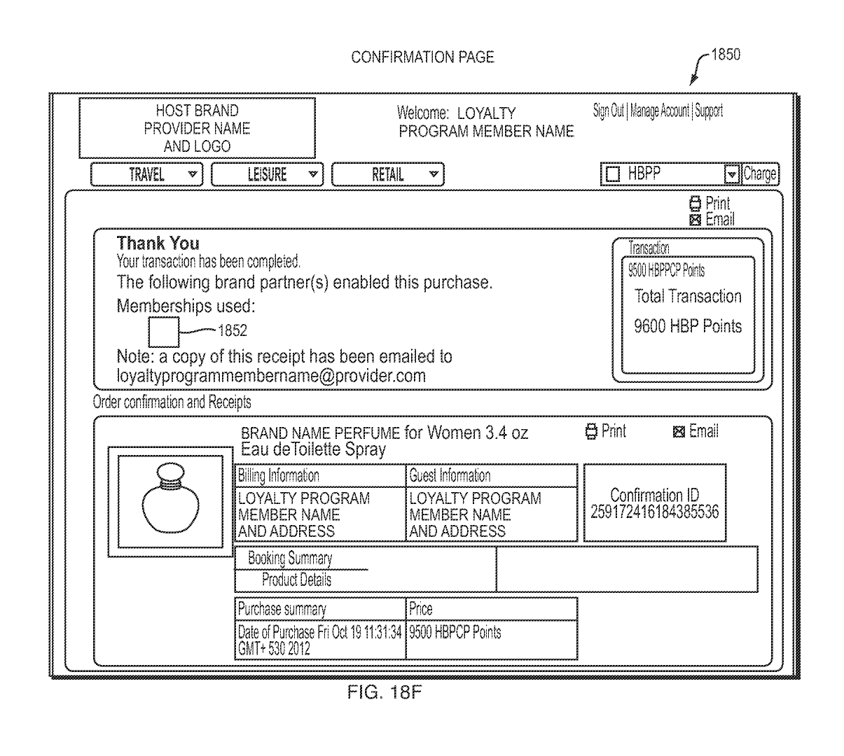

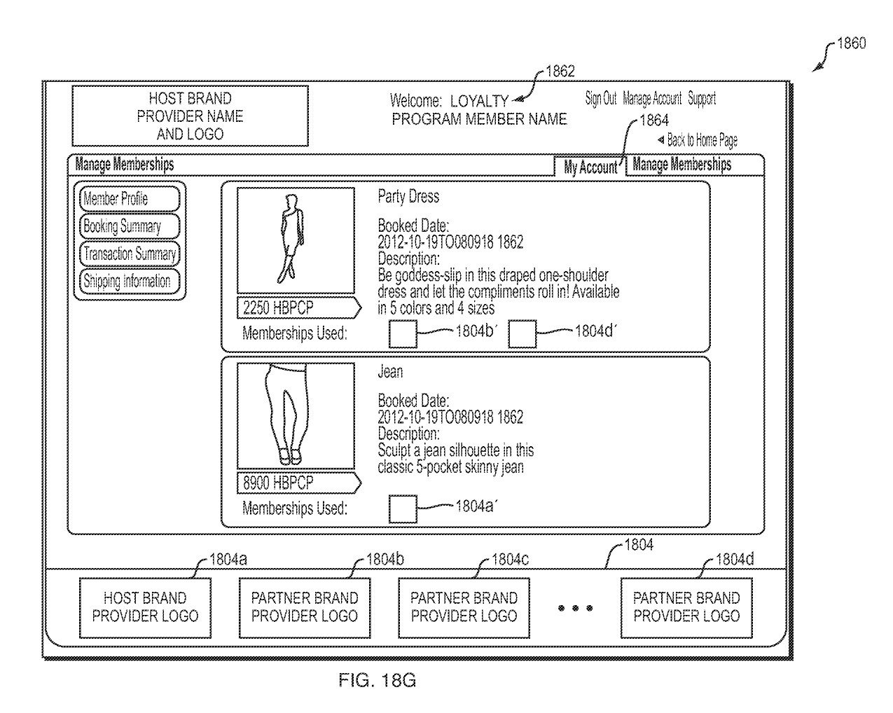

FIG. 18A-G illustrate examples of a user screen experiences with a web application according to techniques disclosed herein.

FIG. 18A shows an example of a log-in page 1800. The page (screen) displayed is an example log in screen for a loyalty program member. The screen may be displayed at an interface associated with a host brand provider 1802. The screen may displays a band 1804 at the bottom of the screen. The band may include representations of partner brand providers 1804a-d in a loyalty program affinity group. The brand provider representations could be in band at the top of the page or shown on the page in any other suitable manner. A representation of the host brand provider may be included on the screen. A representation of the host brand provider's, or any brand provider's, name, logo, acronym, etc., may be provided. The representation may be provided in any suitable manner.

FIG. 18B shows an example of a landing/search page 1810. The landing page may be shown after a loyalty member logs in, and may display representations of all of the loyalty program member's memberships in a “loyalty wallet” 1812 form on one portion of the screen, and search categories 1814 on another portion of the screen (e.g., travel, leisure, and retail). At the bottom of the page, representations of all loyalty program brand providers may be displayed in the band 1804.

FIG. 18C shows an example of a product listings page 1820. Once a loyalty program member chooses a category of choice, the loyalty program member may enter a corresponding key word(s) displayed by the product listings page. The loyalty program member may choose to purchase 1828 a product shown on the product listing page, or view product details 1828 regarding a product of choice. A number of host brand provider points 1824 may be shown associated with the product representation

FIG. 18D shows an example of a product details page 1830. The product details page may display images of the product 1832 detailed with information 1834 on the product, a price of the product 1836, and a Buy Now button 1838.

FIG. 18E shows an example of a currency replenishment page 1840. If the loyalty member has insufficient points, the loyalty program member may be enabled to purchase a product or service through currency replenishment. For example, from the currency replenishment page, the loyalty program member may be enabled to use points earned and accumulated in other loyalty program memberships 1842a-d as per the loyalty program members choice, in order to compensate a deficit, thus, enabling the loyalty program member to complete purchase. A representation of the brand provider 1844a-d may be shown within each loyalty program membership 1842a-d shown, along with the balance, number of points needed to redeem, and an entry box for the number of points the loyalty program member would like to apply towards the purchase. The number of points needed to be redeemed to obtain a product or service of interest may vary between brand providers based on a ratio. For example, as shown in FIG. 18E, from the perspective of the host brand provider (HBP), there is a shortage of 9250 HBP points. The number of points needed to cover the shortage may vary for each brand provider, as shown in 1842a-d.

A product purchase amount may be shown in a form of host brand provider points (HBPP). However, amounts shown in connection with any product or service may be shown in connection with points, monetary or non-monetary currencies, and preferred amounts. For example, an amount may be shown as a monetary international currency or as a non-monetary currency, such as a number of points. Amounts may be shown as preferred amounts based on loyalty member's status, for example, a loyalty member may have preferred status such as platinum, gold, or silver status. Status of any suitable type may be shown. Discounts and offers may be included along with the amounts. Discounts and offers may be based on the loyalty program member's status or location. Product or service amounts may be shown as points plus cash, cash only, different point types, or any other suitable amount or combination thereof may be shown. Product or service amounts may be shown from any perspective including a host brand provider's perspective, another brand provider's perspective, or combination thereof.

FIG. 18F shows an example of a confirmation page 1850. Once a loyalty program member successfully purchases the product, a confirmation page may be displayed, thanking all loyalty program affinity group brand providers that helped in making the purchase happen along with a receipt that may display the confirmation ID and product details. Representations (e.g., brand provider names and logos) of one or more brand providers 1852 in the loyalty program affinity group may be shown to provide recognition for earned values within their loyalty programs that are used to purchase the product or service.

FIG. 18G shows an example of a transaction summary page 1860. To view all of a loyalty program member's previous mobile and web purchases, the loyalty program member 1862 may go to a transaction summary page under My Account 1864. For each transaction, the loyalty program member may be shown representations of the brand providers 1804a′, 1804b′, and 1804d′ in the loyalty program affinity group that contributed earned values within their loyalty programs to the purchase.

A reconciliation process between brand providers may be enabled according to techniques disclosed herein. A reconciliation report may be sent to one or more brand providers in a loyalty program affinity group. The reconciliation report may be generated automatically at a time of purchase to inform brand providers that they contributed to any portion of the purchase. The reconciliation report may be sent at the time or purchase or brand providers may receive reconciliation reports based on an individual brand provider's time-based schedules or balance-based thresholds. The reconciliation report may be generated based on a threshold amount specified, or a time window specified. The reconciliation report may include debts and balances between brand providers and may provide an accounting of points against actual goods sold and replenishment contributions.

The reconciliation report may include an accounting of brand provider monetary or non-monetary currencies used for a purchase. The reconciliation report may summarize or individualize credit or debit between brand providers. Brand providers may determine whether or not a debt needs to be settled based on an accounting included in the reconciliation report. For example, the reconciliation report may indicate that a number of a first brand provider's points were used to replenish a shortage of points associated with another brand provider in order for a loyalty program member to make a purchase. The first brand provider may or may not require payment for the balance owed if the first brand provider recognizes a benefit that may have resulted from other point transactions associated with the debtor.

In some embodiments, an amount, such as $10,000, may be used as a setting under which no monetary funds are exchanged between brand providers and at or over which the debtor brand provider pays the creditor brand provider. Escrow (not shown) with such funds may be employed for automatic “trigger” (i.e., cash payment) transactions.

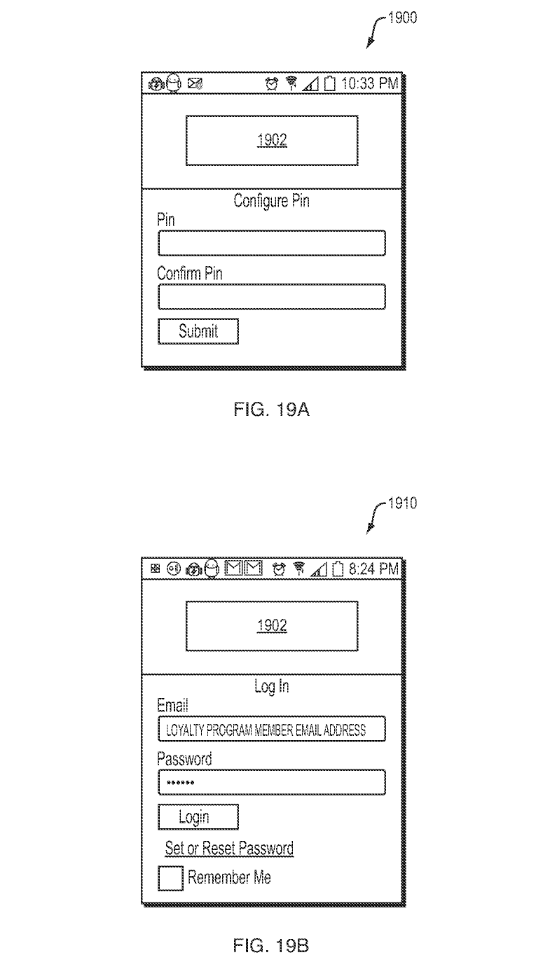

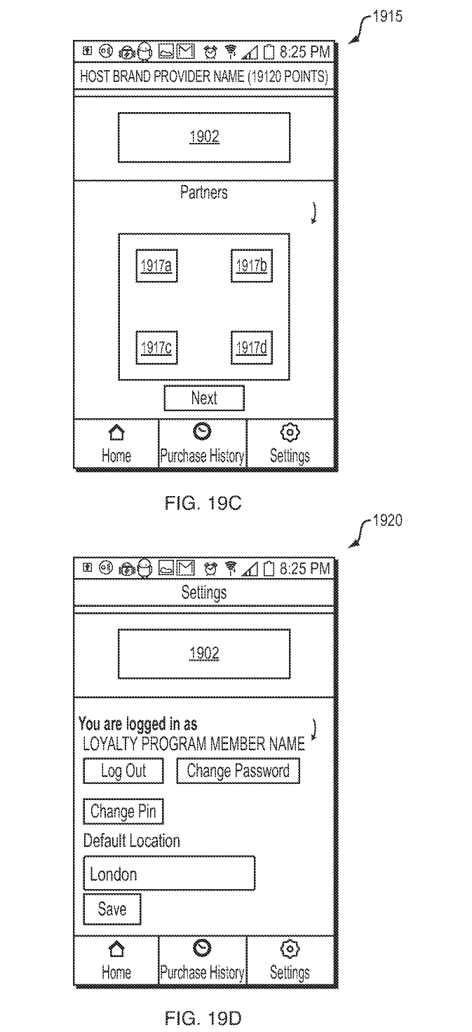

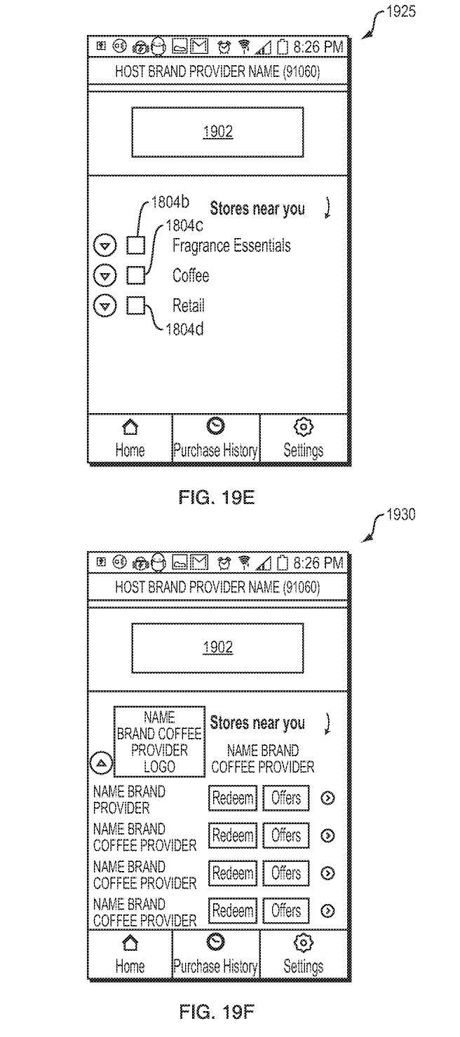

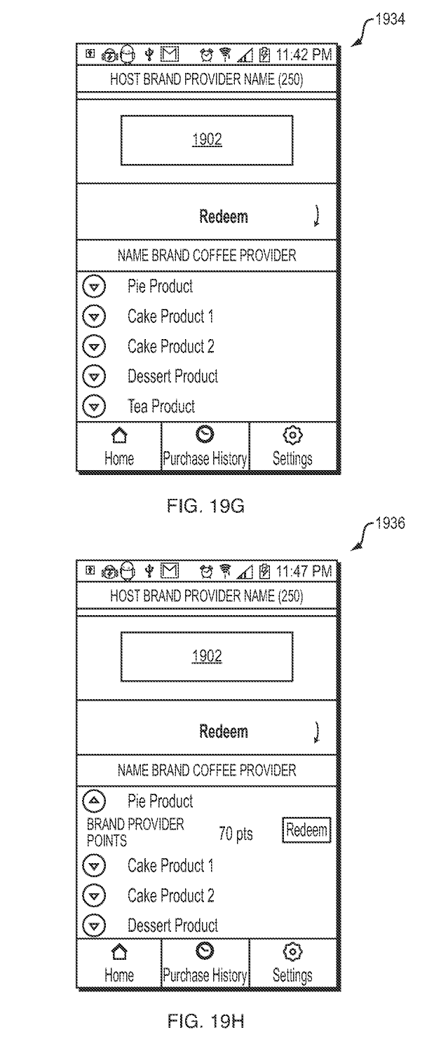

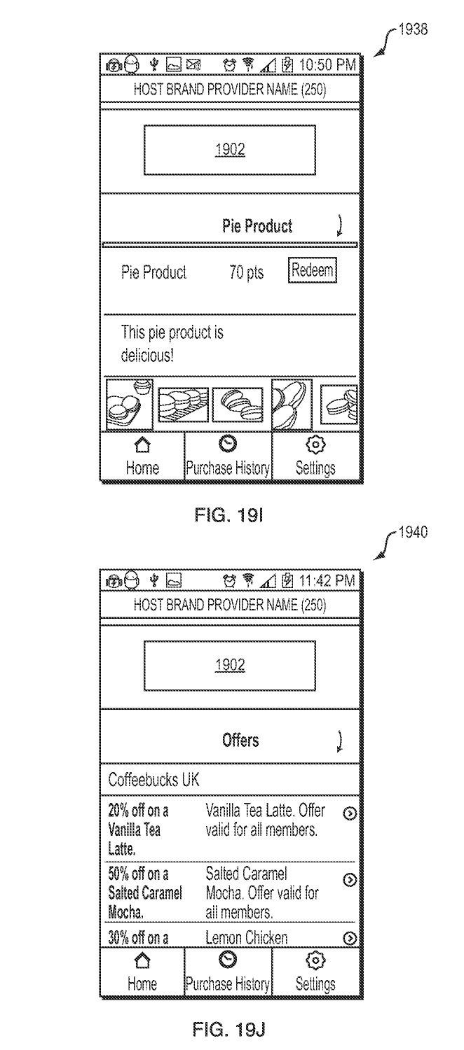

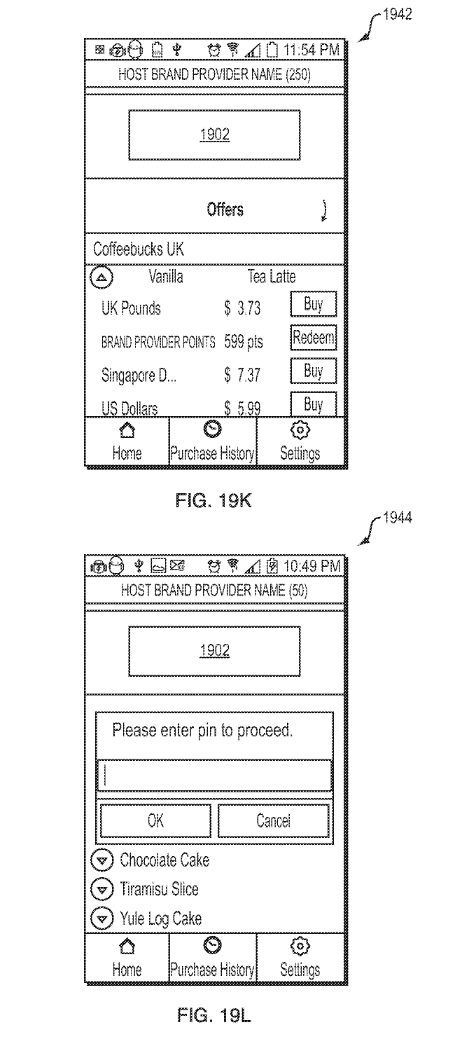

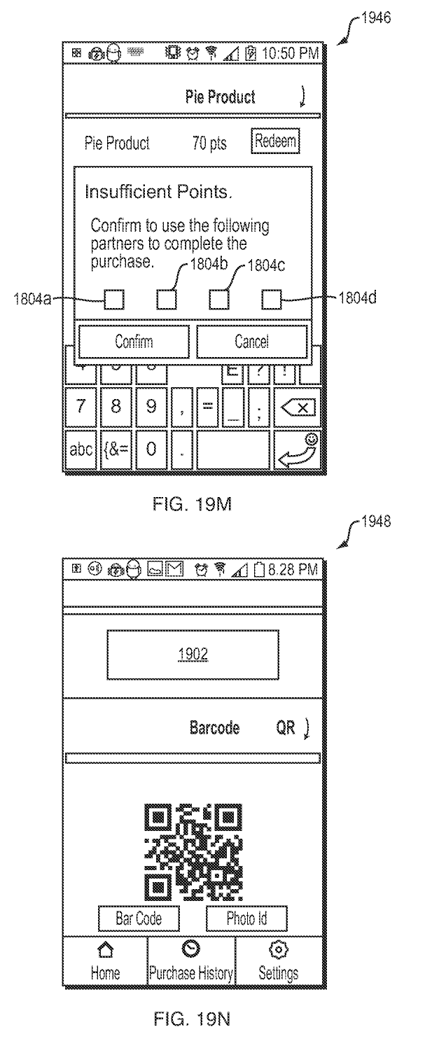

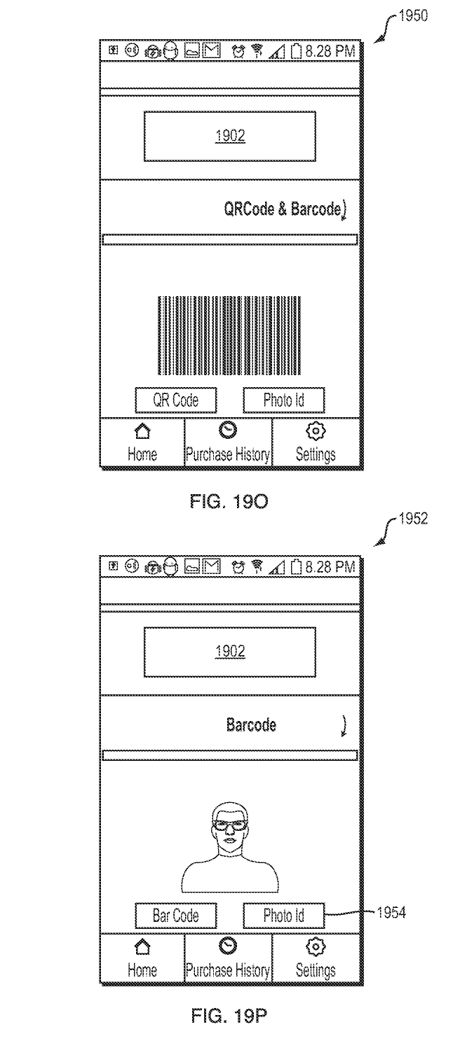

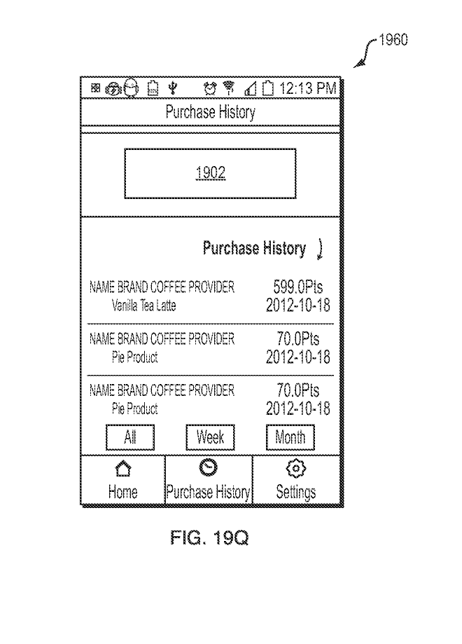

FIG. 19A-Q illustrate examples of a user screen experiences with a web application according to techniques disclosed herein.

FIG. 19A shows an example configure pin screen 1900. As soon as user/loyalty program member download the mobile application, upon opening for a first time, the screen display may enable a user to configure a pin. The screen may display a representation of a brand provider name and logo, the brand provider may be a member or a loyalty program affinity group.

FIG. 19B shows an example of a log in screen 1910. Once the loyalty program member configures a pin number, the log in screen illustrated in FIG. 19B may be shown.

FIG. 19C shows an example landing screen 1915. The landing screen may be displayed once the loyalty program member logs in. The landing screen may display representations of brand providers 1917a-d within a loyalty program affinity group that have loyalty programs of which the loyalty program member is a member.

FIG. 19D shows an example of a set default locations-settings screen 1920. A loyalty program member may choose to use a device, such as a general positioning system (GPS), or other suitable location or navigation device, and locate stores nearby, or set a default location on the screen. A GPS location of a loyalty program member may be used to provide context-relevant offers to the loyalty program member.

FIG. 19E shows an example of a “stores near you” first screen. After setting a location/clicking on a next button located on the landing screen, a listing may be displayed that shows the names or representations of the listing affiliates/brands (e.g., brand providers in the loyalty program affinity group).

FIG. 19F shows an example of a “stores near you” second screen. After a loyalty program member selects a brand provider, all stores of the brand provider that are in the vicinity may be displayed. The loyalty program member may select a store of choice and also choose to redeem loyalty program member points or offer that may be available.

FIG. 19G shows an example of a product listing screen 1934. If the loyalty program member chooses to redeem points, the loyalty program member may be shown the screen with the listing of products (or services) displayed.

FIG. 19H shows an example of a product and price screen 1936. From the listings page, a loyalty program member may view the price of the product and redemm directly, or go to the product details screen.

FIG. 19I shows an example of a product details screen 1938. A loyalty program member may click on the selected product from the 1936 screen and then view product details including images and redeem the same from the screen.

FIG. 19J shows an example of an offers listing screen 1940. A loyalty program member may also select offers from the stores listing page and view a listing of the current offers running at the store.

FIG. 19K shows an example of an offer details screen 1942. A loyalty program member may view details of an offer of the loyalty program member's choice by clicking on the offer, which may then display the offer details screen shown.

FIG. 19L shows an example of a confirm pin before purchase screen 1944. Form the product details page, to redeem points, a loyalty program member may hit the redeem button, and then be prompted to enter the loyalty program member's pin number.

FIG. 19M shows an example of a currency replenishment screen 1946. If the loyalty program member has insufficient points for a purchase, a notification may pop up, prompting the loyalty program member to confirm that the loyalty program member's other membership(s) points may be used to compensate for the deficit.

FIG. 19N shows an example QR code screen 1948. Once a loyalty program member confirms the pin or allows for membership(s) points to be used, a screen displaying a QR code may appear. The code may be scanned at the time of billing. The loyalty program member may also change the QR code to a bar code, and the mobile application may also allow a photo ID.

FIG. 19O shows an example bar code screen 1950. A loyalty program member may receive a bar code that may be used at the time of billing.

FIG. 19P shows an example photo ID screen 1952. A loyalty program member may produce a photo ID by clicking on the photo ID button 1954.

FIG. 19Q shows an example purchase history screen 1960. A loyalty program member may view past purchases by clicking on the purchase history screen.

The teachings of all patents, published applications and references cited herein are incorporated by reference in their entirety.

Further example embodiments of the present invention may be configured using a computer program product; for example, controls may be programmed in software for implementing example embodiments of the present invention. Further example embodiments of the present invention may include a non-transitory computer readable medium containing instruction that may be executed by a processor, and, when executed, cause the processor to complete methods described herein. It should be understood that elements of the block and flow diagrams described herein may be implemented in software, hardware, firmware, or other similar implementation determined in the future. In addition, the elements of the block and flow diagrams described herein may be combined or divided in any manner in software, hardware, or firmware. If implemented in software, the software may be written in any language that can support the example embodiments disclosed herein. The software may be stored in any form of computer readable medium, such as random access memory (RAM), read only memory (ROM), compact disk read only memory (CD-ROM), and so forth. In operation, a general purpose or application specific processor loads and executes software in a manner well understood in the art. It should be understood further that the block and flow diagrams may include more or fewer elements, be arranged or oriented differently, or be represented differently. It should be understood that implementation may dictate the block, flow, and/or network diagrams and the number of block and flow diagrams illustrating the execution of embodiments of the invention.

While this invention has been particularly shown and described with references to example embodiments thereof, it will be understood by those skilled in the art that various changes in form and details may be made therein without departing from the scope of the invention encompassed by the appended claims.

What is claimed is:

1. A method of providing a brand loyalty program environment, the method comprising:
enabling a first brand provider having a first loyalty program to initiate a relationship between itself and at least one second brand provider having at least one respective second loyalty program, the first brand provider and at least one second brand provider within the relationship composing a loyalty program affinity group, the loyalty program affinity group being managed within a server accessible by the first and at least one second brand providers via a computer network; and
enabling brand providers within the loyalty program affinity group to specify a manner in which loyalty program members can combine and use earned values accumulated in the first loyalty program and the at least one respective second loyalty program to purchase goods or services associated with brands of the brand providers within the loyalty program affinity group via the computer network.

2. The method according to claim 1 further comprising:
presenting to a loyalty program member representations of brands, for which the loyalty program member accumulates earned values, in connection with the respective earned values, within the first loyalty program and the at least one respective second loyalty program; and
enabling the loyalty program member to combine and use the earned values, in the manner specified by the brand providers within the loyalty program affinity group, to purchase the goods or services associated with the brands.

3. The method of claim 2 wherein presenting includes presenting via a client device via the computer network.

4. The method of claim 2 further comprising enabling a host brand provider to present to the loyalty program member the representations of the brands, wherein the loyalty program affinity group is unique to affinity relationships of the host brand provider.

5. The method of claim 2 wherein enabling the loyalty program member to combine earned values includes enabling the loyalty program member to combine earned values using at least one of the following: a mobile wallet, check-out payment processor, physical devices optionally including a Point of Sale (POS System), credit card payment terminal using a physical card, Near Field communication device, or radio frequency identification (RFID) device.

6. The method of claim 2 wherein presenting includes presenting at an interface associated with a host brand provider of the brand providers within the loyalty program affinity group accessible by the loyalty program member via the computer network.

7. The method of claim 2 wherein presenting includes presenting at a centralized interface linking brand providers within the loyalty program affinity group accessible by the loyalty program member via the computer network.

8. The method of claim 1 further comprising enabling a loyalty program member to earn values with any combination of the brands of the brand providers within the loyalty program affinity group.

9. The method claim 1 wherein the relationship is a synergistic relationship including an inventory trading relationship or a currency trading relationship.

10. The method of claim 1 wherein the manner specified includes treating earned values in the first loyalty program and the at least one respective second loyalty program under a common value metric system even though purchasing prices for individual branded goods or services associated with brands of the brand providers may be markedly different.

11. The method of claim 1 further comprising determining a common loyalty program value metric for the goods or services associated with brands of the brand providers within the loyalty program affinity group.

12. The method of claim 11 wherein determining the common loyalty program value metric for the goods and services associated with brands of the brand providers within the loyalty program affinity group includes calculating a rate of accrual of loyalty points associated with each brand represented.

13. The method of claim 1 further comprising:
decrementing loyalty program values from each account associated with a loyalty program of the loyalty member as a function of how much value was combined from each account by the loyalty member used in making a purchase.

14. The method of claim 1 wherein the manner specified includes enabling a loyalty program member to apply cash in purchasing the goods or services.

15. The method of claim 1 further comprising enabling brand providers within the loyalty program affinity group to engage in a brand-to-brand (B2B) exchange of products or services with other brand providers within the loyalty program affinity group and to provide rewards to each others' loyalty program members through loyalty points at values below retail cash values of the products or services.

16. The method of claim 1 further comprising:
presenting a loyalty program member at least one possible combination of the earned values from respective brands enabling the loyalty program member to purchase goods or services associated with brands of the brand providers within the loyalty program affinity group.

17. The method of claim 16 further comprising:
accepting input from the loyalty program member to adjust the at least one possible combination of the earned values from respective brands; and
upon receiving the input, automatically recalibrating other earned values from respective brands within the at least one possible combination to enable the loyalty program member to purchase goods or services associated with brands of the brand providers within the loyalty program affinity group.

18. The method of claim 1 further comprising enabling a loyalty program member of the first loyalty program to join the at least one respective second loyalty program of the at least one second brand provider within the loyalty program affinity group for which the loyalty program member is not currently a member.

19. The method of claim 1 wherein the manner specified includes converting loyalty program values of a first brand of the first brand provider to a second brand of the at least one second brand provider within the loyalty program affinity group by using an exchange rate unique to at least two brands including the first brand and the second brand.

20. The method of claim 19 wherein the exchange rate is dynamically determined as a function of at least one of the following: brands associated with the purchase, goods or services associated with the purchase, time, attributes of a purchaser, or promotional offers.

21. The method of claim 1 further comprising:
profiling a consumer base of a plurality of brand providers at the server;
determining a commonality metric between the consumer base of the plurality of brand providers; and
based on the commonality metric, determining whether a synergistic relationship may be formed between at least a subset of the plurality of brand providers.

22. The method of claim 21 further comprising:
providing a recommendation to at least one brand provider of the subset of the plurality of brand providers to form a synergistic relationship with at least one of the brand providers of the subset of the plurality of brand providers, wherein the first brand provider having the first loyalty program initiates the relationship between itself and the at least one second brand provider based on the recommendation.

23. The method of claim 21 further comprising:
accepting a recommendation by the server to form a synergistic relationship with at least one of the brand providers of the subset of the plurality of brand providers, wherein the first brand provider having the first loyalty program initiates the relationship between itself and the at least one second brand provider based on the recommendation accepted.

24. The method of claim 21 further comprising:
using the commonality metric, enabling brand providers to discover other brand providers with which to form a synergistic relationship, wherein the first brand provider having the first loyalty program initiates the relationship between itself and the at least one second brand provider based on the discovery.

25. The method of claim 1 wherein the relationship is a uni-directional or bi-directional inventory trading relationship.

26. The method of claim 1 wherein the earned values accumulated in the first loyalty program and at least one respective second loyalty program are stored in a database accessible by the server via the computer network.

27. The method of claim 1 further comprising:
providing the first brand provider and the at least one second brand provider within the loyalty program affinity group with credit, acknowledgement, or recognition for respective earned values accumulated in the first loyalty program or the at least one respective second loyalty program that are combined by a loyalty program member and used to purchase goods or services associated with brands of the brand providers within the loyalty program affinity group at the time of redemption.

28. The method of claim 1 wherein the goods and services associated with brands of the brand providers are sourced by at least one vendor that is not a brand provider within the loyalty program affinity group.

29. A non-transient computer-readable medium having encoded thereon a sequence of instructions which, when executed by a processor, causes the processor to:
enable a first brand provider having a first loyalty program to initiate a relationship between itself and at least one second brand provider having at least one respective second loyalty program, the first brand provider and at least one second brand provider within the relationship composing a loyalty program affinity group, the loyalty program affinity group being managed within a server accessible by the first and at least one second brand providers via a computer network; and
enable brand providers within the loyalty program affinity group to specify a manner in which loyalty program members can combine and use earned values accumulated in the first loyalty program and the at least one respective second loyalty program to purchase goods or services associated with brands of the brand providers within the loyalty program affinity group via the computer network.
